(19) United States
(12) Patent Application Publication
(10) Pub. No.: US 2017/0116643 A1
(43) Pub. Date: Apr. 27, 2017

(54) ALERT THROTTLING FOR PRODUCT TRACKING

(71) Applicant: MyAlerts Inc., Minneapo1is, MN (US)

(72) Inventors: Douglas M. Berg, Excelsior, MN (US); Robert J. Pappas, Campbell, CA (US)

(21) Appl. No.: 15/298,388

(22) Filed: Oct. 20, 2016

Related U.S. Application Data
(60) Provisional application No. 62/244,860, filed on Oct. 22, 2015.

(51) Int. Cl. G06Q 30/02; G06Q 30/06

(52) U.S. Cl. CPC G06Q 30/0257; G06Q 30/0623

(57) ABSTRACT

A computer-implemented method is presented. The method includes displaying, on a display, a user interface including a user intent input mechanism. The method also includes receiving, from a user, a user intent input with the user intent input mechanism, the user intent input being relative to a product. The method further includes determining a product condition corresponding to the product. In addition, the method includes in response to determining the product condition, identifying, using an alert configuration component, an alert configuration for the product. The method also includes generating, using an alert generator, an offer alert based on the alert configuration, and providing the offer alert, using a communication component, to the user.

### CROSS-REFERENCE TO RELATED APPLICATION

The present application is based on and claims the benefit of U.S. provisional patent application Ser. No. 62/244,860, filed Oct. 22, 2015, the content of which is hereby incorporated by reference in its entirety.

### BACKGROUND

There are a wide variety of computing systems currently in use. Many computing systems exist to facilitate commercial transactions, and may allow a user to, perhaps through a web browser interface, purchase a desired commodity. For example, a user may navigate to a retailer website and search for a product. Upon finding the desired product, the user may select the product for purchase or save the product in a virtual shopping bin for later action.

Retailers generally desire a high rate of sale to customer access. In other words, they desire sales to be completed each time a consumer accesses their product library. This can lead to increased revenue. However, particular circumstances may interfere with the ability of a retailer to complete a transaction, thereby resulting in lost-revenue.

### SUMMARY

A computer-implemented method is presented. The method includes displaying, on a display, a user interface including a user intent input mechanism. The method also includes receiving, from a user, a user intent input with the user intent input mechanism, the user intent input being relative to a product. The method further includes determining a product condition corresponding to the product. In addition, the method includes in response to determining the product condition, identifying, using an alert configuration component, an alert configuration for the product. The method also includes generating, using an alert generator, an offer alert based on the alert configuration, and providing the offer alert, using a communication component, to the user.

### BRIEF DESCRIPTION OF THE DRAWINGS

FIG. 1 is a block diagram of an example alert throttling system in a transaction environment, in accordance with one embodiment of the present invention.

FIG. 2 shows a flow diagram of one example method of throttling alerts, in accordance with one embodiment of the present invention.

FIGS. 3A-3C show some examples of user interaction environments generated by an alert throttling system, in accordance with one embodiment of the present invention.

FIG. 4 shows a flow diagram of a method of personalizing alerts, in accordance with one embodiment of the present invention.

FIGS. 5A-5I show example user interface displays for personalizing alerts, in accordance with one embodiment of the present invention.

FIG. 6 illustratively shows a flow diagram of a method of generating price variation predictions, in accordance with one embodiment of the present invention.

FIGS. 7A-7B show example user interface displays for price variation predictions, in accordance with on embodiment of the present invention.

FIG. 8 shows a flow diagram of a method of performing a policy match adjustment, according to one embodiment of the present invention.

FIG. 9 shows an example user interface display for a performing a policy match adjustment, in accordance with one embodiment of the present invention.

FIG. 10 shows one embodiment of a mobile computing device that may be configured to facilitate the interaction between a computing system and a user, which may be used in some embodiments of the present invention.

FIG. 11 shows one embodiment of a computing device that may be configured to facilitate the interaction between a computing system and a user, which may be used in some embodiments of the present invention.

FIG. 12 illustrates a block diagram of one embodiment of a computing environment, which may be used in some embodiments of the present invention.

FIG. 13 illustrates a simplified block diagram of one embodiment of a computing device, which may be used in some embodiments of the present invention.

FIG. 14 illustrates a block diagram of one embodiment of an encompassing computing environment, which may be used in some embodiments of the present invention.

### DETAILED DESCRIPTION OF ILLUSTRATIVE EMBODIMENTS

Managing product offerings while attempting to account for fluctuations in both product availability and the interest of consumers is currently cumbersome. Consumers interested in acquiring a product typically navigate to an online retail environment to complete a transaction. For instance, consumers may access a website of a retailer and input a search for a desired product. In response to a search input, the website may provide a list of products along with associated images, descriptions, and pricing. The consumer may then attempt to purchase a product or add the product to a virtual shopping cart for later action.

Products are typically presented to consumers without taking into consideration factors regarding the availability of the product and the relative interest in the product. For example, the retailer website might provide a list of products regardless of whether those products are currently available for purchase (e.g. whether a product is in-stock).

Therefore, in conventional systems, a consumer might request a transaction on a product but be denied because the product is actually out of stock. Until the consumer attempted the transaction, the consumer perceived that the product was ready for purchase. As initial matter, this can result in negative customer sentiment, which can in turn negatively affect a retailers' business operations. For example, upon discovering that a desired product is unavailable, consumers are likely to leave one retailer in an attempt to acquire the product from another retailer. Often, users will navigate to a different website (e.g. a competing retailer website) to attempt to purchase the product.

Consumer desire for immediate product access is increasingly prevalent in today's online retail space, as both the number of retail providers has increased, and hurdles to consumer access has decreased. This makes it easy for consumers to take their business elsewhere if the item they want is unexpectedly unavailable. When potential customers leave one retailer for another, the retailer that initially captured consumer interest loses revenue. In addition, the consumer is left with a negative view of the retailer that was not able to, at the request of the consumer, complete the transaction.

Of course, consumers may leave one retailer for another for a variety of reasons other than a product being unavailable. Consumers might look elsewhere for a cheaper price, cheaper shipping costs, or for the product to be bundled with other products of interest, among others. Regardless, it is desirable to deter consumers from leaving a retailer upon accessing that retailer. Embodiments described herein may provide mechanisms that aid in decreasing lost retailer opportunity (e.g. aid in preventing a consumer from leaving one retailer to use a competing retailer).

In conventional systems, interest in products and the availability of those products can be unpredictable for a retailer. At any time, a retailer might have hundreds or thousands of products in a product catalog. These products might be considered in-stock or out-of-stock based on an inventory level of the product. For example, if there are 500 products currently in the inventory of a retailer, that product might be considered to be in-stock. Alternatively, if there are no products currently in the inventory, the product might be considered out-of-stock.

The inventory of products can change rapidly and in response to various factors. For instance, items may go out of stock on both a regular basis due to, for example, predictable increases in sales during holiday seasons; or on an irregular basis due to, for example, a heightened interest in a particular product.

In addition, if the retailer wishes to provide consumers with special product offers (e.g. a limited time sale price or discount), consumer response to the offers can unpredictably affect availability. However, an issue remains where there is a lack of transparency between product information (e.g. availability and interest) and how product offers are generated.

Thus, there is a need for an alert throttling system that generates alerts based on a variety of parameters to decrease lost retail opportunity. These parameters may be set by, for instance, an administrator of a retail environment. The parameters may include rules that govern the type and content of the alerts, the recipients, when the alerts will be provided to the recipients, a frequency at which the alerts will be sent, etc. The parameters may also be associated with product tracking information. Product tracking information can indicate an inventory level, a consumer interest level, or other information specific to a product or group of products.

In one embodiment, an alert throttling system includes a cross-retail platform to service a variety of retail providers. In one embodiment, the system monitors a variety of product pages to determine item availability information, perform analyses, and generate alerts based on the availability information and analyses. Thus, the system described herein may be useful for configuring offers for high-demand products so that consumer environments do not over-communicate and create frustration for consumers. The system may further provide the ability for consumers to opt-in to receive future product alerts. Research has indicated that more than 50% of consumers, upon receiving an indication that a desired product is currently unavailable for purchase, will opt-in to receiving a product alert that is generated when the product has become available.

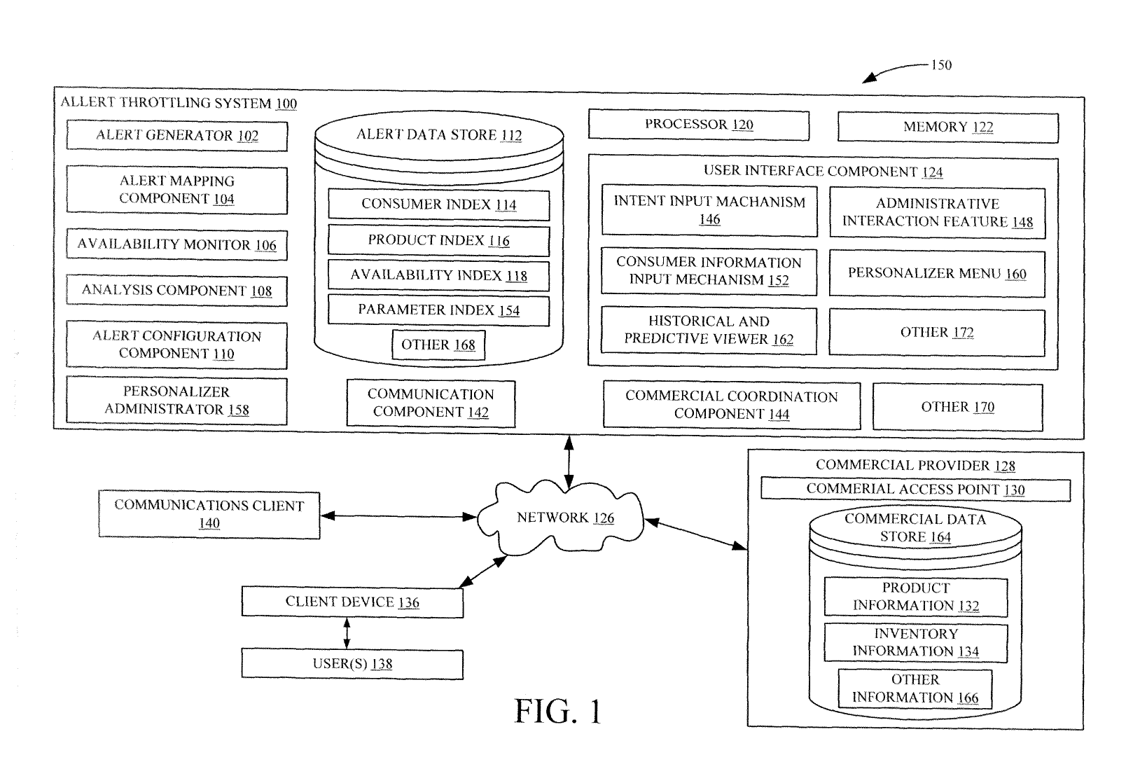

FIG. 1 is a block diagram of an example alert throttling system in a transaction environment, in accordance with one embodiment of the present invention. Alert throttling system 100 is illustratively configured to operate in a transaction environment 150. Transaction environment 150, in one embodiment, includes a platform for coordination between alert throttling system 100, commercial provider 128, one or more users 138, and communications client 140. Transaction environment 150 also illustratively includes a network 126. Network 126 may include any of: a wide area network (WAN), a local area network (LAN), an Internet area network (IAN) or any other suitable network configuration. Network 126 facilitates the interaction between a variety of users 138 and the various systems of transaction environment 150.

In one embodiment, alert throttling system 100 includes alert generator 102, alert mapping component 104, availability monitor 106, analysis component 108, alert configuration component 110, alert data store 112, processor 120, memory 122, user interface component 124, communications component 142, commercial coordination component 144, personalizer administrator 158, and other components 170. In one embodiment, data store 112 includes consumer index 114, product index 116, availability index 118, and other index 168. Further, in one embodiment, user interface component 124 includes intent input mechanism 146, administrative interaction feature 148, consumer information input mechanism 152, personalizer menu 160, historical and predictive viewer 162, and other user interface components 172. While these particular components will be discussed in further detail below, it is expressly contemplated that a variety of additional components may also or alternatively be used. Further, alert throttling system 100 could be configured with a different arrangement, or with only a subset of the illustrated components.

Processor 120 is a functional part of alert throttling system 100 that is activated by and facilitates the functionality of the components in system 100. Memory 122 may be a variety of memory storage configurations such as, but not limited to: computer storage media in the form of random access memory (RAM), dynamic random access memory (D-RAM), flash, or another volatile or non-volatile memory storage configuration. Further, alert data store 112 may comprise a variety of different databases that store various information. As such, a user 138 may write, update, modify, and/or delete data included in alert data store 112. However, it is noted that not all users 138 may have access to alert data store 112. Data store 112 may also include one or more configurations of storable memory, in one embodiment. Memory included with data store 112 may include, for example, any of: random access memory (RAM), dynamic random access memory (D-RAM), flash, or another volatile or non-volatile memory storage configuration. For instance, in one embodiment, memory 122 is in communication with alert data store 112. In one embodiment, data store 112 may be accessed remotely over, for instance, network 126. Further, in one embodiment, data store 112 comprises a plurality of data stores such as a distributed database system.

In one embodiment, alert throttling system 100 includes locally operating application that is, for instance, installed and configured to operate at client device 136. For purposes of illustration only, alert throttling system 100 will be further described as a cloud-implemented application service with access to various system components across network 126. Further, it is illustratively shown that alert throttling system 100 is a single system. In another embodiment, alert throttling system 100 is separated into multiple systems that are implemented across a wired or wireless environment.

Commercial provider 128, in one embodiment, includes commercial access point 130 and commercial data store 164. Commercial access point 130 can include a variety of user-accessible information. In one embodiment, commercial access point 130 comprises a web page specific to commercial provider 128. User 138 can access commercial access point 130 to search for products, view product information 132, read reviews, etc. For example, but not by limitation, commercial provider 128 could be the retailer The Home Depot®, with a corresponding commercial access point 130 of www.homedepot.com. Commercial provider 128 may be a variety of other retailers with a commercial access point 130. Some example providers 128 include but are not limited to: Target®; BestBuy®; CostPlus World Market®; Amazon®; or any other online retailer. As such, commercial provider 128 may include a variety of information relating to products being sold by the provider. In one embodiment, commercial data store 164 includes product information 132, inventory information 134, and other information 166. Commercial data store 164 may be accessible by alert throttling system 100 to obtain information that is used in generating alerts. In another embodiment, product information 132 and inventory information 134 are included at commercial access point 130. For example, the information is included at a webpage for a particular product.

In one embodiment, product information 132 comprises any information that identifies a particular product. For example, product information 132 may include any of: a product name, serial number, manufacturer, description, material, size, color, packaging, warranty terms, price (e.g. price look up code (PLU)), web address at which product information is accessed with commercial access point 130, or any other unique identifier. Product information 132 may therefore include information for all or a particular set of products that are offered for sale by commercial provider 128. In one embodiment, inventory information 134 comprises any information that identifies current, past, or potential future inventory associated with each product of product information 132. For instance, inventory information 134 may include any of: inventory feed, stock keeping unit (SKU), purchase records, shipping records, and a variety of other related information particular to each product offered by commercial provider 128. Regardless of their storage location and content, product information 132 and inventory information 134 are accessible by alert throttling system 100, in one embodiment, by using network 126.

Alert throttling system 100 illustratively includes a commercial coordination component 144, which is configured to communicate with commercial provider 128 to obtain product information 132 and/or inventory information 134. In one embodiment, commercial coordination component 144 retrieves commercial access point 130 by, for example, crawling a product web page that is generated by the commercial provider. For example, commercial coordination component 144 may use optical character recognition (OCR) to parse textual information generated at commercial access point 130. In one embodiment, commercial coordination component 144 generates a request for product information 132 and inventory information 134 from commercial provider 128 and receives the requested information upon return of the request from the provider. Commercial coordination component 144 may also integrate user interface features and input mechanisms, generated by user interface component 124, with commercial provider 128 such that alert throttling system 100 can be used across a variety of retailers.

Alert throttling system 100 further illustratively includes a user interface component 124. In one embodiment, user interface component 124 is configured to generate user interface displays that can be provided to client device 136, which is accessible by user 138. One such user interface display may include features that allow a user to indicate a product of interest. For instance, user interface component 124 illustratively includes an intent input mechanism 146. Intent input mechanism 146 may include any user input mechanisms capable of being actuated to capture a user intent to acquire and/or establish interest in a product. In one embodiment, an intent input mechanism 146 comprises a user-actuable input that, when actuated, initiates a transaction operation to enable the user to purchase the identified product. In another embodiment, intent input mechanism 146 may be actuated to indicate an “add to cart”, “save for later”, or any other available action with respect to a product. Intent input mechanism 146 may include a wide variety of user input mechanisms such as a button, text entry field, voice command, drop-down menu, etc., that, when actuated by user 138, identify an intent to perform an action with respect to an item.

In one embodiment, user interface component 124 is configured to generate intent input mechanism 146 and provide intent input mechanism 146 to commercial coordination component 144, which may further provide intent input mechanism 146 for generation with commercial access point 130. For example, intent input mechanisms 146 are provided to a web page (e.g. commercial access point 130) corresponding to commercial provider 128.

In one embodiment, user interface component 124 is configured to generate a consumer information input mechanism 152 for commercial coordination component 144. Commercial coordination component 144 may, in one embodiment, provide consumer information input mechanism 152 to commercial access point 130. Consumer information input mechanism 152 can include any user input mechanisms capable of being actuated to capture a unique identifier associated with a user 138 (e.g. activating an intent input mechanism 146). In one embodiment, consumer information input mechanism 152 comprises a user-actuable text box that is displayed at a commercial access point 130 to capture an email address associated with user 138. Consumer information input mechanism 152 may be configured to capture a wide variety of unique identifiers. In one embodiment, consumer information input mechanism 152 may capture any of: a username, unique purchase history, Internet Protocol (IP) address, social media profile, among others. In one embodiment, consumer information input mechanism 152 is generated in response to actuation of an associated intent input mechanism 146. In another embodiment, for example, consumer information input mechanism 152 is generated in response to an indication that a product of interest is currently unavailable for transaction. As such, consumer information input mechanism 152 may be configured to capture a decision of user 138 to opt-in to future alerts for the identified product of interest. Of course, user interface component 124 can also or alternatively include a variety of other input mechanisms and features to facilitate throttling alerts with alert throttling system 100.

In one embodiment, user interface component 124 illustratively includes administrative interaction features 148. In one embodiment, administrative interaction features 148 comprise one or more user interface displays that provide user 138 with the ability to customize alerting configurability. For example, administrative interaction features 148 comprise an application interface that walks user 138 through the necessary steps and receives the user inputs required to set one or more parameters for alert throttling system 100.

Alert throttling system 100, in one embodiment, includes an alert configuration component 110. In one embodiment, alert configuration component 110 can be configured by user 138 with administrative interaction features 148 of user interface component 124. For example, the application interface provided by administrative interaction features 148 may allow an administrator of alert throttling system 100 (e.g. user 138) to set alerting configurations according to one or more parameters and/or rules. Based on the parameters and/or rules defined by alert configuration component 110, alert generator 102 generates one or more alerts for a particular product. For instance, the parameters are indicative of the alert to be performed.

Alert mapping component 104, in one embodiment, is configured to parse the parameters to parameter index 154 to identify configurations set by user 138. In one embodiment, alert mapping component 104 can parse a unique consumer identification (e.g. provided by a user 138 with consumer information input mechanisms 152) to consumer index 114. In one embodiment, alert mapping component 104 parses product information 132 to product index 116. In one embodiment, alert mapping component 104 parses and inventory information to availability index 118 at data store 112. In one embodiment, alert mapping component 104 parses alerts generated by alert generator 102 to alert index 156. Alert mapping component 104 may therefore generate a tabular store of data, stored in alert data store 112, that maps each alert generated by alert generator 102 to a particular consumer, product, inventory feed, and one or more parameters that trigger providing the alerts to user 138.

Alert throttling system 100 also illustratively includes a communications component 142. In one embodiment, communications component 142 is configured to provide alerts generated by alert generator 102 to communications client 140 over network 126. In one embodiment, but not by limitation, communications client 140 comprises an email client to which user 138 is subscribed. In another embodiment, communications client 140 may comprise any of a variety of different client applications that are accessible by user 138 to receive alerts from alert throttling system 100. For instance, communications client 140 can be any variety of communication services including, but not limited to: short messaging service (SMS), multimedia messaging service (MMS), enhanced messaging service (EMS), etc.

Alert throttling system 100 further illustratively includes an availability monitor 106. In one embodiment, availability monitor 106 is configured to monitor the availability of products stored at alert data store 112. For instance, an alert is generated by alert generator 102 and the alert is mapped with alert mapping component 104 to parameter index 154. In one embodiment, parameter index 154 includes a parameter identified with alert configuration component 110. The parameter may require that, for example, at least 200 in-stock units of the product are available prior to providing the alert to user 138 using communications component 142. Availability monitor 106 may monitor availability index 118 to determine when the parameter is met; in this example, when at least 200 units of the product are in-stock. In addition, availability monitor 106, in one embodiment, may request additional inventory information such as, for example, an inventory feed from commercial coordination component 144. Commercial coordination component may, in one embodiment, be instructed by availability monitor 106 to provide an inventory feed that includes both product information 132 and inventory information 134.

As such, in one embodiment, availability monitor 104 generates a real-time product inventory feed that is utilized by alert throttling system 100 to generate efficient and reliable alerts. In one embodiment, the frequency and timing of monitoring availability index 118, and requesting additional information may be defined, in part, by the parameters set with alert configuration component 110. For example, an administrator (e.g., user 138) may set a parameter that instructs availability monitor 106 to request inventory information from commercial coordination component 144 every two days (e.g. a timed interval of 48 hours) after availability information indicates that the item has gone out of stock. In another embodiment, availability monitor 106 may request such information directly from commercial provider 128. It is contemplated herein that a variety of additional or alternative parameters may be used in other embodiments. In one embodiment, configuring alert throttling system can decrease bandwidth consumption by limiting unnecessary requests of information in environment 150.

In one embodiment, alert throttling system 100 includes an analysis component 108. In one embodiment, analysis component 108 is configured to perform an analysis with respect to information stored at alert data store 112. For example, analysis component 108 may perform any of: statistical analyses, descriptive analyses, and/or inferential analyses on data stored in alert data store 112. In one embodiment, analysis component 108 is configured to perform analyses on alerts that have been provided by communications component 142, and any changes to product index 116, availability index 118, and any of the other information stored at store 112.

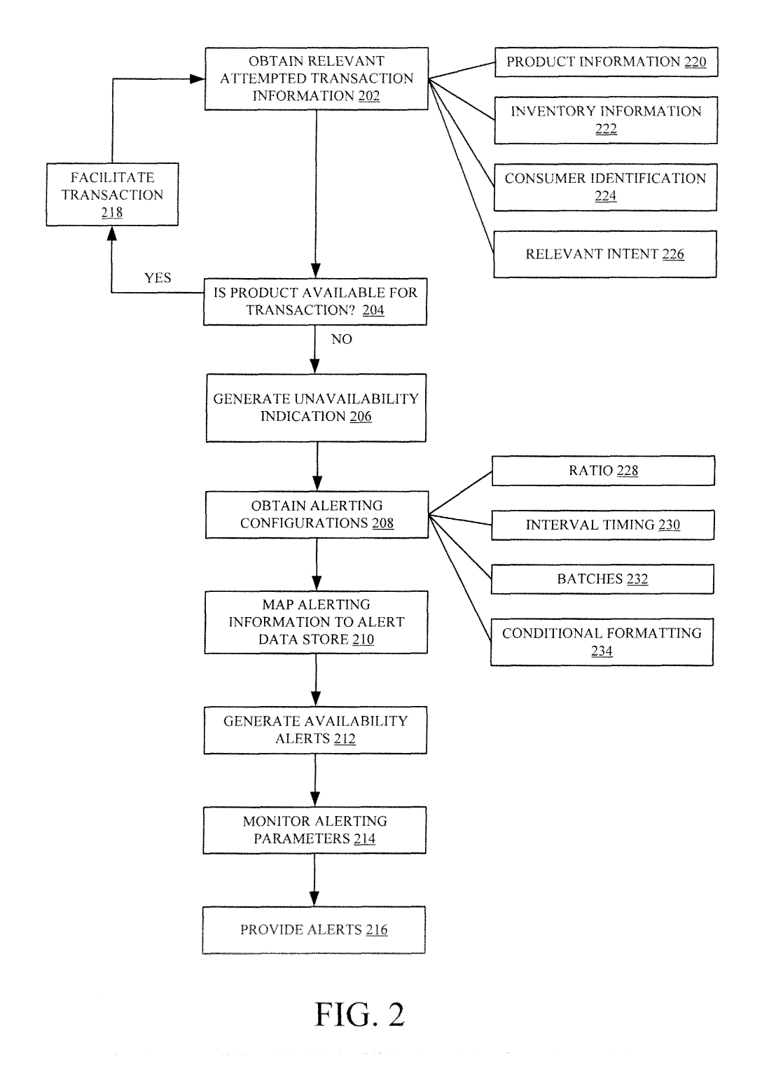

FIG. 2 shows a flow diagram of one example method of throttling alerts, in accordance with one embodiment of the present invention. At block 202, an alert throttling system obtains relevant attempted transaction information. In one embodiment, obtaining attempted transaction information comprises obtaining any of: product information, as indicated by block 220; inventory information, as indicated by block 222; consumer identification, as indicated by block 224; and/or a relevant intent, as indicated by block 226.

In one embodiment, obtaining relevant transaction information includes a user accessing a product web page by interacting with a commercial access point. While visiting the product page, a user may attempt to initiate a transaction on an item of interest by selecting a ‘purchase’ option provided by an intent input mechanism. In one embodiment, an intent input mechanism may be generated by either a commercial provider or alert throttling system, or a combination of both. In response to receiving user actuation of an intent input mechanism, in on embodiment, an alert throttling system captures relevant intent, as indicated by block 226, with a commercial coordination component. Relevant intent, as indicated by block 226, may comprise the intent of the consumer to purchase the product, save the product for later action, gift the product to a friend, etc.

In one embodiment, obtaining relevant transaction information includes a commercial coordination component being automatically activated to obtain product information 220 and/or inventory information 222. For example, a commercial coordination component may be activated to obtain information from a commercial provider in response to one or more alert configurations or a determination of product availability. In one embodiment, product information 220 includes any of the information discussed with respect to product information 132. Further, in one embodiment, inventory information includes any of the information discussed with respect to inventory information 134.

In one embodiment, obtaining relevant transaction information includes a commercial coordination component being configured to obtain a consumer identification 224. Consumer identification 224 may include a wide variety of information that identifies a user. In one embodiment, consumer identification 224 includes any of the information discussed with respect to that which is captured with consumer information input mechanism 152. For instance, consumer identification 224 may identify a username, unique purchase history, IP address, social media profile, or any other unique identifier. In one embodiment, a consumer information input mechanism is generated in response to actuation of an intent input mechanism. For example, a user is presented with a consumer information input mechanism in response to obtaining an indication of an attempted transaction. The generated consumer information input mechanism may include a text box entry field that, when actuated, allows a user to provide the system with an email address, for example.

At block 204, an alert throttling system determines if the identified product is available for transaction. In one embodiment, determining availability comprises a commercial coordination component determining whether the identified product is available for purchase. For example, a commercial coordination component may be configured to receive a product inventory feed that is indicative or product availability. Determining whether the identified product is available, in one embodiment, comprises analyzing the obtained inventory information 222. For example, an analysis component may perform a variety of analyses to determine that there is a sufficient or insufficient amount of product inventory required to complete the transaction.

If the product is available (e.g. currently in-stock), a commercial coordination component may be configured to provide relevant information to an alert mapping component and allow a commercial provider to facilitate the requested transaction.

At block 218, a transaction is facilitated. It is noted that the facilitating the transaction, in one embodiment, may be carried out separately from alert throttling system 100 by, for instance, a commercial provider. To the alternative, in one embodiment, a commercial coordination component may be configured to facilitate the transaction by performing block 218.

If, however, a commercial coordination component determines (e.g. either individually with product information from a commercial provider, or in combination with one or more analyses provided by an analysis component) that the product of interest is currently unavailable for transaction (e.g. the product is currently out-of-stock), a commercial coordination component may instruct a user interface component to generate an out-of-stock item indication. This is generally indicated at block 206, which illustratively includes generating an unavailability indication. For example, a user interface component generates a dialog that is provided to a user and indicates that the desired item is currently unavailable for purchase. In one embodiment, a user interface component provides the dialog or other out-of-stock indication with the product web page interface (e.g. commercial access point 130). In one embodiment, user 138 may access a product web page and select “purchase” from the product web page interface in an attempt to acquire a product offered by a commercial provider. An alert throttling system is thus configured determine whether the product is available for transaction, and inform the user that the product of interest is not currently available, as indicated at block 206.

In one embodiment, a consumer information input mechanism is generated in response to a determination that an item is currently unavailable. However, in another embodiment, a consumer information input mechanism may be generated in response to a variety of considerations including, but not limited to, a set of rules or parameters associated with alert throttling system.

For example, upon receiving a user input to purchase an item (e.g. actuating intent input mechanism 146) and generating an indication that the item is unavailable, a user interface component may generate a consumer information input mechanism to capture an email address of the consumer. For example, when a user attempts to purchase a product, the system will determine that the item is currently unavailable and generate an input mechanism that allows the user to enter an email address and therefore opt-in to future product alerts generated by the system.

Actions that are taken by an alert throttling system upon receiving an indication of an unavailable product may depend on alert parameters set by an alert configuration component. In one embodiment, actions taken by alert throttling system are not in response to receiving product or consumer information, or an indication of consumer intent. Rather, in one embodiment, actions of an alert throttling system can be generated based on information stored at an alert data store and in accordance with parameters set with an alert configuration component.

At block 208 of method 200, an alert throttling system obtains an alerting configuration. If the system determines that the identified product is not available for transaction, method 200 may proceed to block 208 (e.g., with or without generating an unavailability indication). In one embodiment, an alert configuration component generates a request to an alert data store to determine any alerting configurations associated with the obtained product information 220. For example, an alert configuration component generates a request to a data store to receive any of obtained inventory information 222, consumer identification 224, and relevant intent 226. As such, in one embodiment, block 206 includes obtaining an alerting configuration that has been previously generated by an alert generator and mapped to an alert data store with an alert mapping component. The system may thus determine if any pre-existing alerting configurations have been set for the identified product.

In one embodiment, obtaining an alerting configuration, as indicated in block 208, comprises prompting an administrator (e.g. user 138 using administrative interaction features 148) to set parameters for generating and providing an alert. For instance, upon determining that a product is out-of-stock, the system generates an alerting application interface that is provided to an administrator. The application interface includes, in one embodiment, one or more administrative interaction features 148, which present the administrator with options for configuring how, when, and what types of alerts will be generated by the system. In one embodiment, block 208 comprises obtaining any of the parameters including, but not limited to: a ratio, as indicated by block 228; an interval timing, as indicated by block 230; a batch, as indicated by block 232; and/or a conditional formatting, as indicated by block 234, which may each be configured with administrative interaction feature 148. It is also contemplated that an administrative interaction feature can be generated and presented to an administrator so that, upon identification of a relevant product, the system obtains the set parameters and performs method 200 accordingly.

Ratio parameter, as indicated by block 228, comprises, in one embodiment, a ratio of alerts generated to interested parties. For instance, obtaining a ratio comprises obtaining an indication of the number of alerts to be generated and the number of consumers that will receive the generated alerts. As an example, an administrator may use the alert throttling system to set a ratio of one alert to each identified consumer. In this example, if 400 consumers have opted-in to alerts (e.g., as indicated with consumer identification information, as indicated at block 222), 400 alerts will be generated and each of the 400 identified consumers will receive a single alert. In another embodiment, obtaining a ratio, as indicated at block 228, comprises obtaining an indication of how many parties are likely to purchase the identified product if presented with an alert. For example, from market research or statistical analyses identified by an analysis component, the system may identify a ratio that illustrates that one in three consumers who opted-in to alerts are likely to proceed with purchasing the item. As such, a ratio parameter, as indicated at block 228, may identify that the number of alerts generated by alert generator 102 will be approximately one third of the number of consumers identified at block 222. For example, in an example where 450 consumers are identified (e.g. by analyzing, with an analysis component, consumer identification information, as indicated at block 224), a ratio, as indicated at block 228, may set a rule for alert generator that allows the generator to generate 150 alerts based on a one-third consumer-to-availability ratio.

In one embodiment, obtaining an alerting configuration comprises obtaining parameters indicative of interval timing, as indicated at block 230. Obtaining interval timing, in one embodiment, includes obtaining any variety of timing configurations that determine when alerts are to be generated, sent to consumers, etc., and can be based on a variety of factors. For example, interval timing 230 comprises obtaining an indication that alerts are to be generated by alert generator 102 every seven days for the ensuing six months. Of course, a variety of intervals of time can be used. For example, every day for a week, every month for a period of one year, on national holidays, etc. In another embodiment, interval timing 228 includes instructions for a commercial coordination component to generate an inventory feed at specific timing intervals. For instance, a commercial coordination component may be configured to request an inventory update from commercial provider every hour during business hours of the provider.

In one embodiment, obtaining an alerting configuration comprises obtaining a batch parameter, as indicated at block 232. In one embodiment, a batch parameter includes an indication of one or more groups (e.g. batches) of users and/or products. For example, an administrator may select one or more identified products or consumers to be group together into one or more batches. In one embodiment, an alert mapping component utilizes batch parameter, as indicated at block 232, to form groups of alerting operations with the same or similar parameters. For example, two products that are currently unavailable may be grouped into the same batch such that an alert parameter is applied to a single group. Similarly, for instance, two or more users can be grouped into the same batch. For instance, a plurality of users that have provided a relevant intent for an item that is currently unavailable may be grouped together with an alert configuration component in accordance with one or more batch parameters, as indicated at block 232. As such, all users within the batch will receive the same alerts according to the same parameters.

In one embodiment, obtaining an alerting configuration comprises obtaining a conditional formatting parameter, as indicated at block 234. Conditional formatting, as indicated at block 234, may include, in one embodiment, one or more specific rules for alerting that may not be attainable using the parameters discussed above. In one embodiment, conditional formatting comprises a rule that governs how and when alerts are generated and presented to a user. There are a variety of conditional formatting parameters that may be used with a system. One such example of a conditional formatting parameter sets forth a condition that must be satisfied for an action to be taken. For example, obtaining conditional formatting may include obtaining a rule that states if the inventory for a product has not changed (e.g. the inventory for the product has not decreased over a specified period of time), alerts are to be generated by an alert generator.

In one embodiment, to facilitate capturing potentially lost revenue (e.g. revenue that would be lost in conventional systems due to a user navigating to a competitor retailer site in an attempt to purchase the same or similar product that is unavailable at the current retailer site) an alert throttling system is configured to perform a variety of operations that generate alerts and provide alerts to consumers that have shown interest in a particular item. These alerts and the parameters discussed above may allow an administrator of an alert throttling system to generate product alerts and offers while being considerate to the consumer. In one embodiment, alert throttling system 100 aids a commercial provider in avoiding the generation of false product alerts, such as indicating to a user that a product is available for purchase when in fact it has just gone out of stock. Therefore, embodiments described herein can increase accuracy and reliability of generating product alerts and providing them to an interested party.

At block 210, alerting information is mapped to an alert data store. In one embodiment, an alert mapping component maps the information obtained at block 202 (e.g. the obtained product information 220, inventory information 222, consumer identification 224, and relevant intent 226) to one or more indexes. For example, alert mapping component 104 maps the obtained information to a consumer index, product index, and availability index. As such, alerting information can be mapped to an alert data store for use by an alert generator and various other components of an alert throttling system.

At block 212, in one embodiment, availability alerts are generated. In one embodiment, generating availability alerts comprises accessing the mapped information stored at an alert data store and determining whether set parameters have been satisfied. When parameters (e.g. configurations set in accordance with block 208) have been satisfied, the system may use an alert generator to generate alerts and store the alerts at alert index 156. As such, block 212 may also include storing the generated alerts at a data store. In one example, an alert configuration sets a rule stating that there must be twice as much available product than interested consumers for alerts to be generated. Therefore, in the example when product availability for the identified product is twice as much as the number of consumers, availability alerts are generated.

Alert index 156 may comprise a variety of alerts that have been generated by the system and mapped at data store 112 with specific consumers, products, and inventory information. Therefore, method 200 may provide the ability to generate a diverse set of alerts for a variety of consumers that have indicated interest in many different products.

At block 214, in one embodiment, an alert alerting parameter for the generated alert is monitored. While alerts are generated based on whether the alerting configurations are satisfied (e.g. block 208), product availability and consumer interest can change dramatically in a relatively short amount of time. Therefore, it can be useful to ensure that set rules remain satisfied prior to providing the generated alerts. In one embodiment, an availability monitor monitors an inventory feed for an identified product. If, for example, the availability monitor determines that the inventory feed drops below a specified amount (e.g. below the amount set with the parameter) then the availability monitor will flag the generated alert. In one embodiment, if the parameters are monitored and a condition of the parameters ceases to be satisfied, then generating alerts may be halted until that condition returns to an acceptable value. Of course, a variety of additional monitoring actions can be performed in accordance with block 214.

At block 216, in one embodiment, the generated alerts are provided to a user. If the conditions are satisfied during the monitoring of the parameters, the generated alerts may be provided in accordance with the alerting configurations. Therefore, a user mapped with a consumer index at an alert data store will be provided the generated alerts. In one embodiment, providing alerts includes sending the alerts to the mapped user 138 with communications component 142. Communications component can be configured to communicate with communications client 140 such as, for instance, an email client. Providing alerts may thus include generating an email communication that includes a link to the now-available product at commercial provider 128. In another embodiment, providing the alerts includes generating an indication of the alert at commercial access point 130. For instance, system 100 is configured to generate a dialog user interface display that is provided in accordance with block 216.

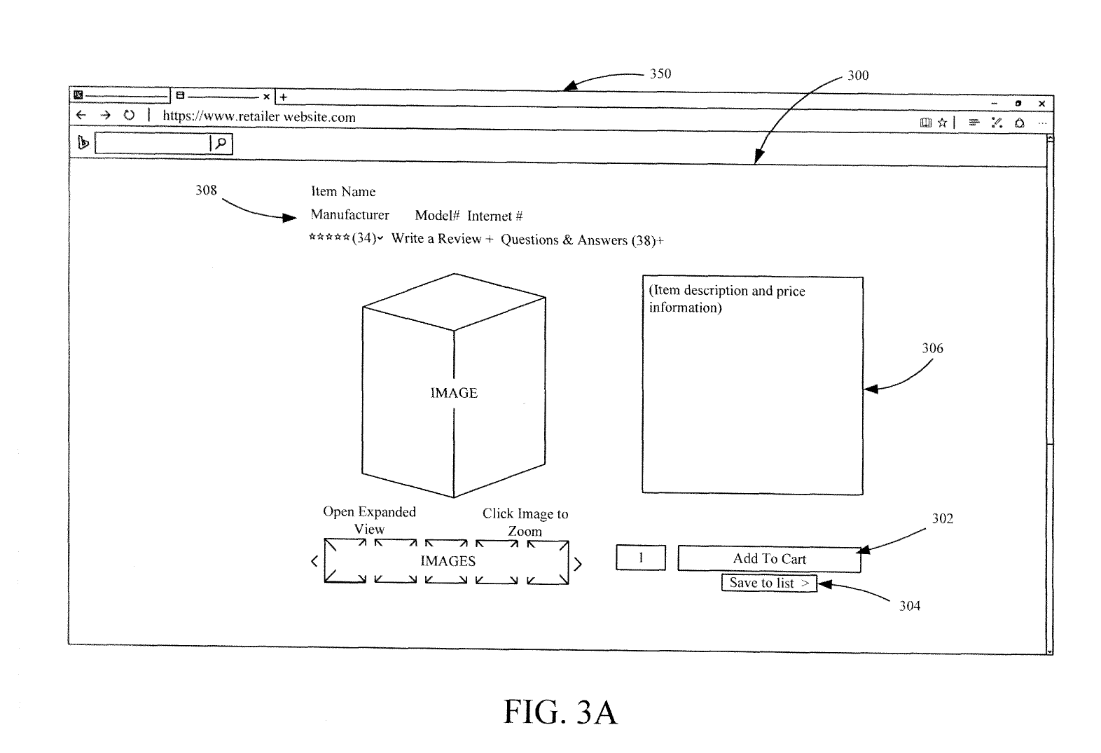

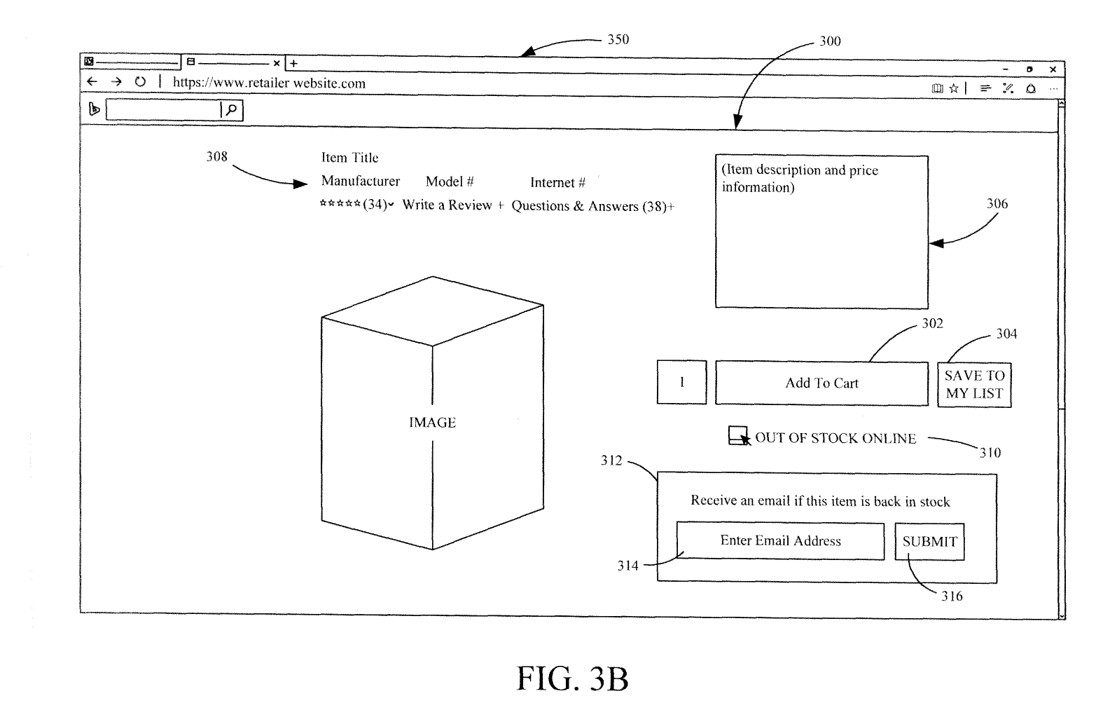

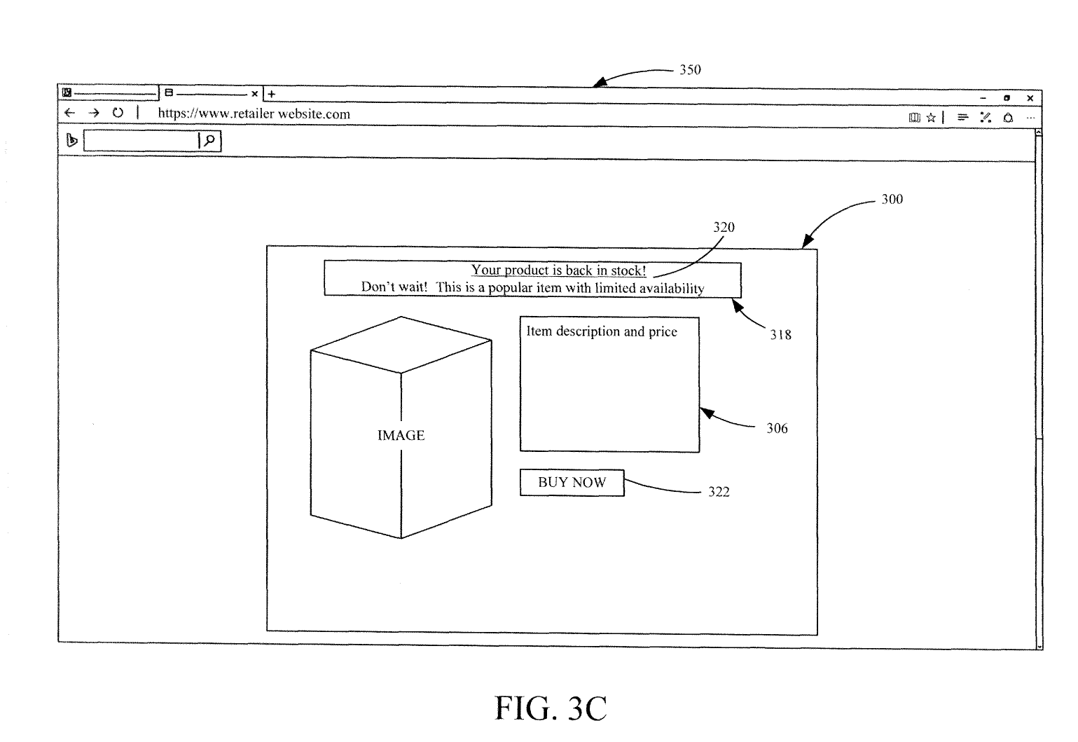

FIGS. 3A-3C show some examples of user interaction environments generated by an alert throttling system, in accordance with one embodiment of the present invention. FIG. 3A generally depicts a user interface display 300 that is generated at a commercial access point. For example, user interface display 300 comprises one or more features discussed with respect to user interface component 124 of alert throttling system 100. User interface display 300 is illustratively integrated with a retailer website of a web browser interface 350. In one embodiment, system 100 integrates display 300 with commercial access point 130 of commercial provider 128 by using commercial coordination component 144.

It is shown in FIG. 3A that, in one embodiment, user interface display 300 comprises product information portions, generally indicated by reference numerals 306 and 308. In one embodiment, product information and/or inventory information is accessed by a commercial coordination component by performing a text recognition operation on the product information portions 306 and 308. As such, an item name, model number, internet number, description, price, in-stock indication, and a variety of other descriptive information can be obtained.

FIG. 3A further illustratively includes user intent input mechanisms, generally represented with reference numerals 302 and 304. Accordingly, a user can actuate input mechanism 302 to attempt a transaction. Similarly, a user may actuate input mechanism 304 to save the produce in a virtual shopping list. In one embodiment, actuation of user input mechanisms 302 and/or 304 comprises obtaining relevant intent information.

FIG. 3B generally shows a user interface display 300 that indicates that a product is currently unavailable for transaction. It is shown in FIG. 3B that an out of stock indication 310 is generated upon the system determining that the product is unavailable. Further, user interface display 300 includes an alert prompt 312 that includes a consumer information input mechanism 314 and a submission input mechanism 316. In one embodiment, input mechanisms 314 and 316 include consumer information input mechanisms. Therefore, the system can obtain relevant attempted transaction information such as a consumer identification. In one embodiment, user input mechanism 314 and 316 are generated in response to a determination that a product is unavailable. In another embodiment, however, user input mechanisms 314 and 316 are generated at when information included in display 300 is generated (e.g. at a time of loading the webpage). As such, embodiments herein disclose an interface that is generated to capture a unique identification for a user upon informing the user that the item of interest is currently unavailable. Capturing user information when the user is viewing the product of interest may allow an alert throttling system to generate alerts tailored to that user, thereby increasing exposure and access to products offered for sale by a commercial provider.

FIG. 3C generally shows a user interface display 300 generated in response to a determination that a tracked product is now available for transaction. In one embodiment, an alerting system determines that a product is available, and perhaps that specific conditions for that product or unique user identification have been met, and generates display 300 to include an availability alert 318. It is illustratively shown that availability alert 318 comprises an actuable link 320. The system may receive user actuation of generated link 320 and, in response, navigate display 300 to the product page associated with the product of interest.

Until now, embodiments described herein have primarily been focused on how administrators of, for example, a retailer service can throttle alerts for their products. In addition to customizing alerts based on parameters set by retailers (where, perhaps alerts are set for a specific product, batch of products or users, etc.), embodiments herein also disclose systems and methods for throttling alerts in accordance with a personalizer administrator. In one embodiment, a personalizer administrator is configured to assist a user (e.g. a consumer or end-retail user) in determining which type of alerts to receive. The type of alerts can be based on a variety of user-identified interests.

Referring back to FIG. 1, in one embodiment, alert throttling system 100 includes personalizer administrator 158. In one embodiment, personalizer administrator 158 is configured to capture interests of user 138 accessing a variety of commercial providers 128. For example, personalizer administrator is configured to be compatible as a cross-retail platform within environment 150. In one embodiment, personalizer administrator 158 is configured to generate personalizer menu 160. Personalizer menu 160 may be provided with user interface component 124, and may be adapted for use with commercial access point 130 such that a plurality of retailers can provide consumers with an easy-to-use user interface for customizing product alerts. For instance, commercial coordination component 144 facilitates the integration of personalizer menu 160 with commercial access point 130.

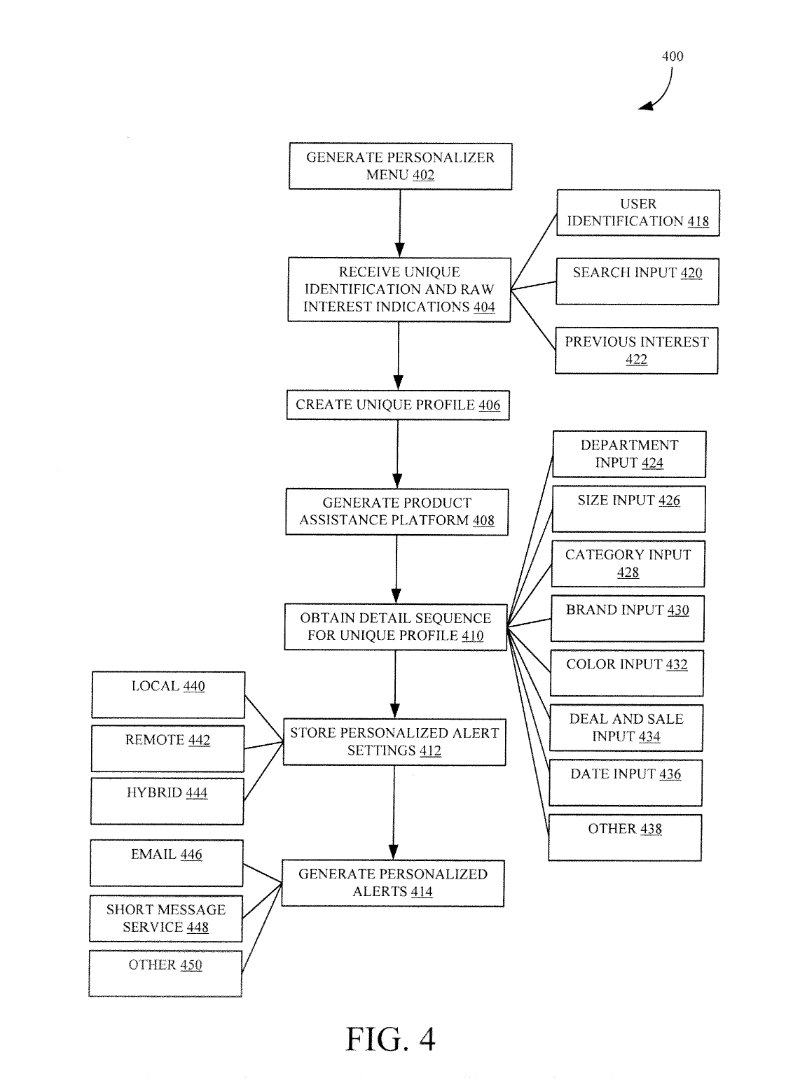

FIG. 4 shows a flow diagram of a method of personalizing alerts, in accordance with one embodiment of the present invention. Some of method 400 involves the adaptability of personalizer menu 160.

At block 402, in one embodiment, a personalizer menu is generated. In one embodiment, generating a personalizer menu may include generating, with a personalizer administrator, one or more user interfaces and input mechanisms that facilitate assisting a user in identifying interests. Generating a personalizer menu may include generating a menu that is unique for a specific commercial provider. Generating a personalizer menu may also or alternatively include generating a menu that is applicable across many different commercial access points. As such, in one embodiment, a personalizer menu may be customizable by, for example, an administrator of an alert throttling system, a commercial provider, or another user.

At block 404, in one embodiment, a unique identification and one or more raw interest indications are received. In one embodiment, receiving a unique identification comprises receiving a user input of a name and email address with a registration input mechanism. For example, a user identification is received, as indicated at block 418. A variety of user identifications may be received with a registration input mechanism including any of: a username, unique purchase history, IP address, social media profile, phone number, among others.

In one embodiment, raw interest indications may also be received at block 404. Raw interest indications may include any indication of the product of interest that the user would like to personalize alerts for. In one embodiment, raw interest indications include receiving a search input. Receiving a search input is generally indicated at block 420. For example, a search input may include an input received at the commercial access point that indicates a product the user would like to view. In one embodiment, receiving raw interest indications includes receiving or determining previous interest. Using previous interest for raw interest indications is generally indicated at block 422. For example, prior use with a personalizer menu may be stored and subsequently accessed for, for instance, a particular user associated with the user identification obtained at block 418.

At block 406, in one embodiment, a unique profile is generated. For example, a user may actuate an input to instruct the system to create a unique profile. In one embodiment, a personalizer administrator is configured to generate a unique profile that is identifiable by the provided user identification. Information regarding the unique profile may be stored at an alert data store or another suitable storage location.

At block 408, in one embodiment, a product assistance platform is generated. Based on, for instance, the information provided with a personalization input mechanism, a personalizer administrator is configured to generate one or more product assistance platforms. In one embodiment, the product assistance platform comprises a sequence of interfaces with one or more prompts presented to a user to capture interests for customizing alerts.

At block 410, in one embodiment, a detail sequence for a unique profile is obtained. Obtaining a detail sequence includes, in one embodiment, dynamically updating a personalizer menu as information is received to aid in customizing alerts. One such way of receiving information and using that information to update the menu includes utilizing product interest indications provided with personalization input mechanisms. As such, a detail sequence includes, in one embodiment, a collection of indications provided with personalization input mechanisms. In one embodiment, obtaining a detail sequence includes obtaining any of: a department selection input, as indicated at block 424; a size selection input, as indicated at block 426; a category selection input, as indicated at block 428; a brand selection input, as indicated at block 430; a color selection input, as indicated at block 432; a deal and sale selection input, as indicated at block 434; a date selection input, as indicated at block 436; and/or other selection input, as indicated at block 438. In one embodiment, obtaining a department selection input, as indicated at 424, includes obtaining an input indicative of the department that a product is sold in. In one embodiment, obtaining a size selection input, as indicated at block 426, includes obtaining an input indicative of a size of a product. In one embodiment, obtaining a category selection input, as indicated at block 428, includes obtaining an input indicative of the category of products that the user is interested in. In one embodiment, obtaining a brand selection input, as indicated at block 430, includes obtaining an input indicative of the designer and/or manufacturer of a product. In one embodiment, obtaining a color selection input, as indicated at block 432, includes obtaining an input indicative of the color of product that a user is interested in. In one embodiment, obtaining a deal and sale selection input, as indicated at block 434, includes obtaining an input indicative of a type of deal or sale that the user would like included in a product offering. In one embodiment, obtaining a date selection input, as indicated at block 436, includes obtaining an input indicative of a date the user would like to have the product be available, offered for a cheaper price, or any other relevant date that the user has interest in and would like to receive an alert in accordance with. In one embodiment, obtaining other selection input, as indicated at block 438, includes obtaining an input indicative of any other alerting parameters that the user would like included in the personalized alert settings.

At block 412, in one embodiment, personalized alert settings are stored. In one embodiment, a personalizer administrator receives the personalization inputs and instructs the alert throttling system to store the received inputs. As such, a capture of product interest can be obtained and stored as personalized alert settings. Further, in one embodiment, the unique identification information is stored along with the personalized settings. As such, a personalizer administrator may call on an alert data store to obtain personalized alert preferences for a particular user. In one embodiment, alert settings are stored locally with respect to the user. Storing alert preferences locally is generally indicated at block 440. For example, alert preferences may be stored at a locally operating system that executes a browser application to generate a commercial access point (e.g. a product website). In another embodiment, alert settings are stored remotely. Storing alert preferences remotely is generally indicated at block 442. For example, alert preferences may be stored at a server associated with a commercial provider, or an alert throttling system, among others. Alert preferences may also be stored in a hybrid storage configuration, such as a distributed database. Storing the alert preferences in a hybrid storage is generally indicated at block 444.

At block 414, in one embodiment, personalized alerts are generated. Generating personalized alerts includes, in one embodiment, using a personalizer administrator to analyze the various inputs received with personalization user input mechanisms. With the analyzed information, an alert throttling system is configured to generate personalized alerts. Further, in one embodiment, generating personalized alerts includes providing the alerts to the users associated with the stored personalizer alert settings. The generated alerts may be provided to a user in a variety of ways. In one embodiment, the system is configured to provide the generated alerts to a user using a communications client, such as an email client. As such, providing the alerts to a user with an email communication is generally indicated at block 446. In another embodiment, the system is configured to provide the alerts using a short messaging service (SMS), as generally indicated by block 448. Of course, the system may be configured to provide the generated alerts to a user using other communication methods, as generally indicated by block 450.

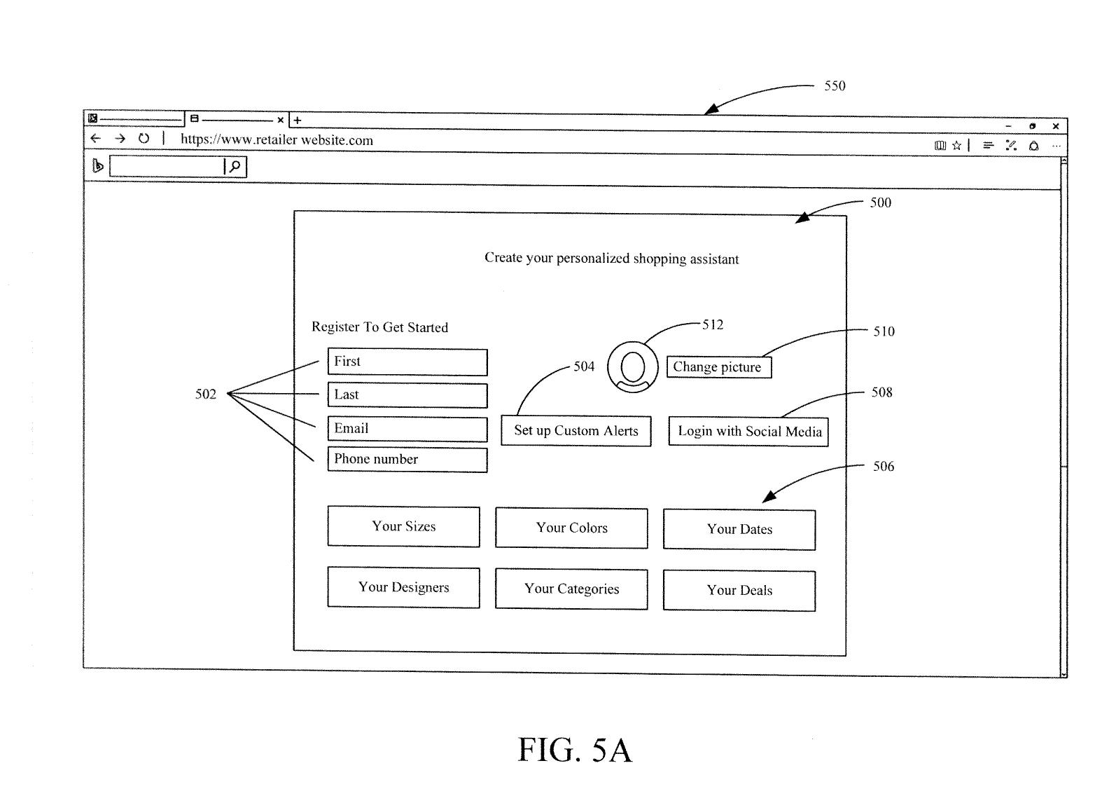

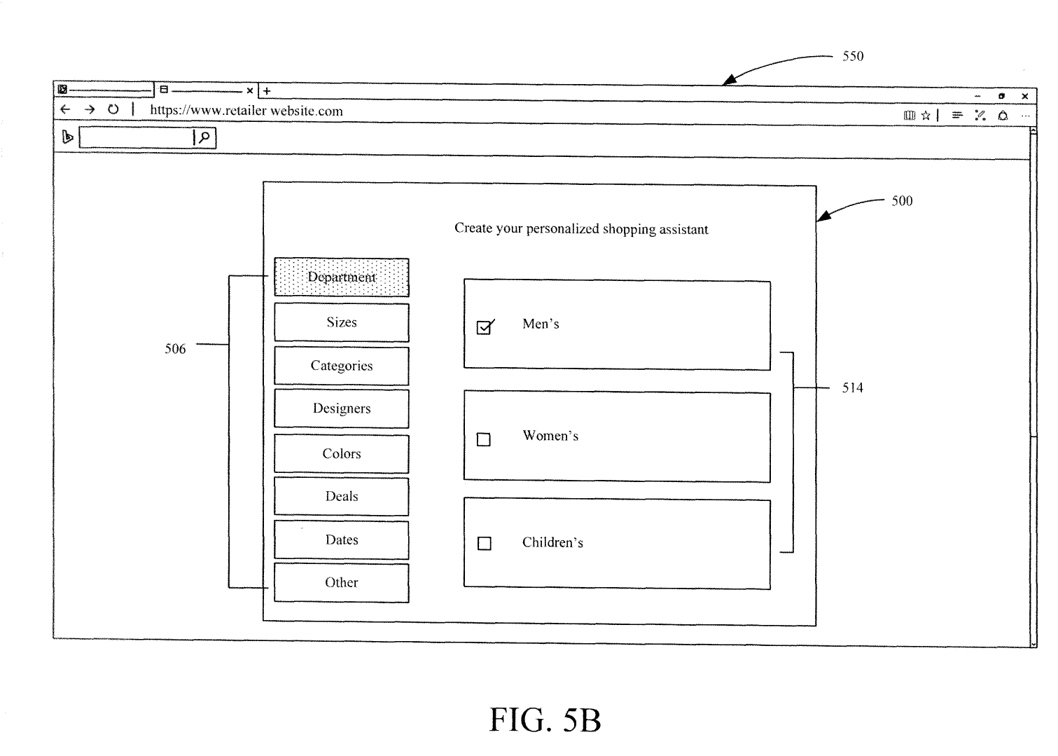

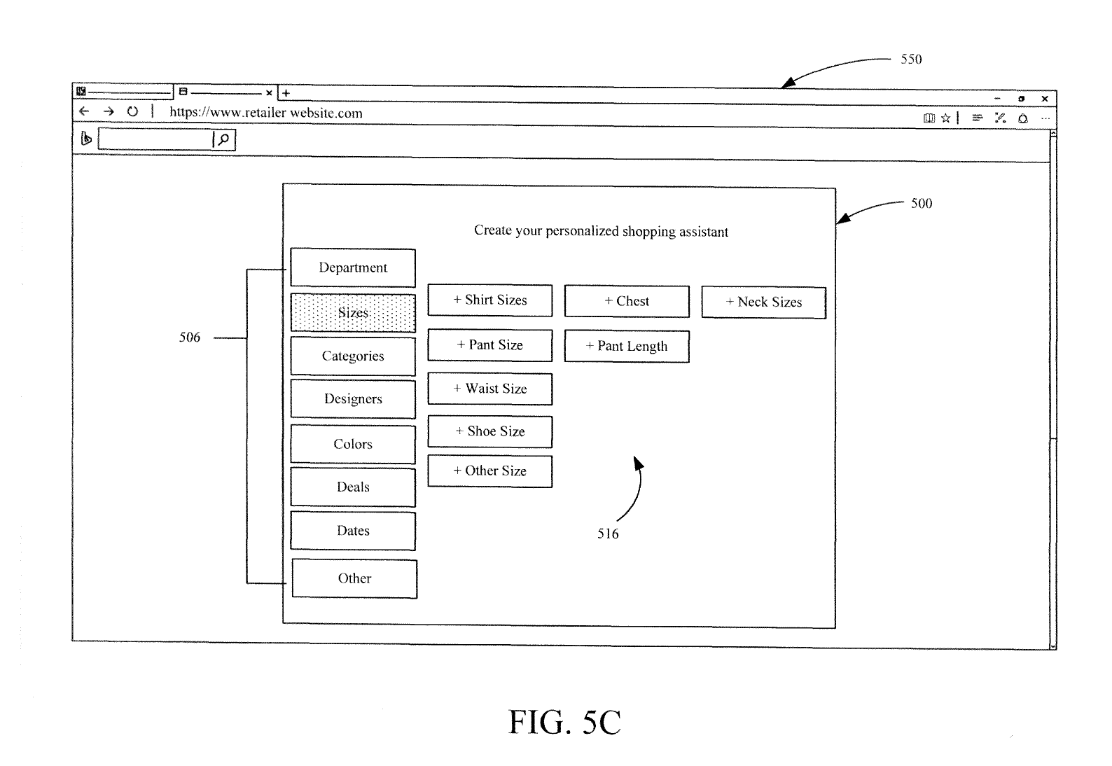

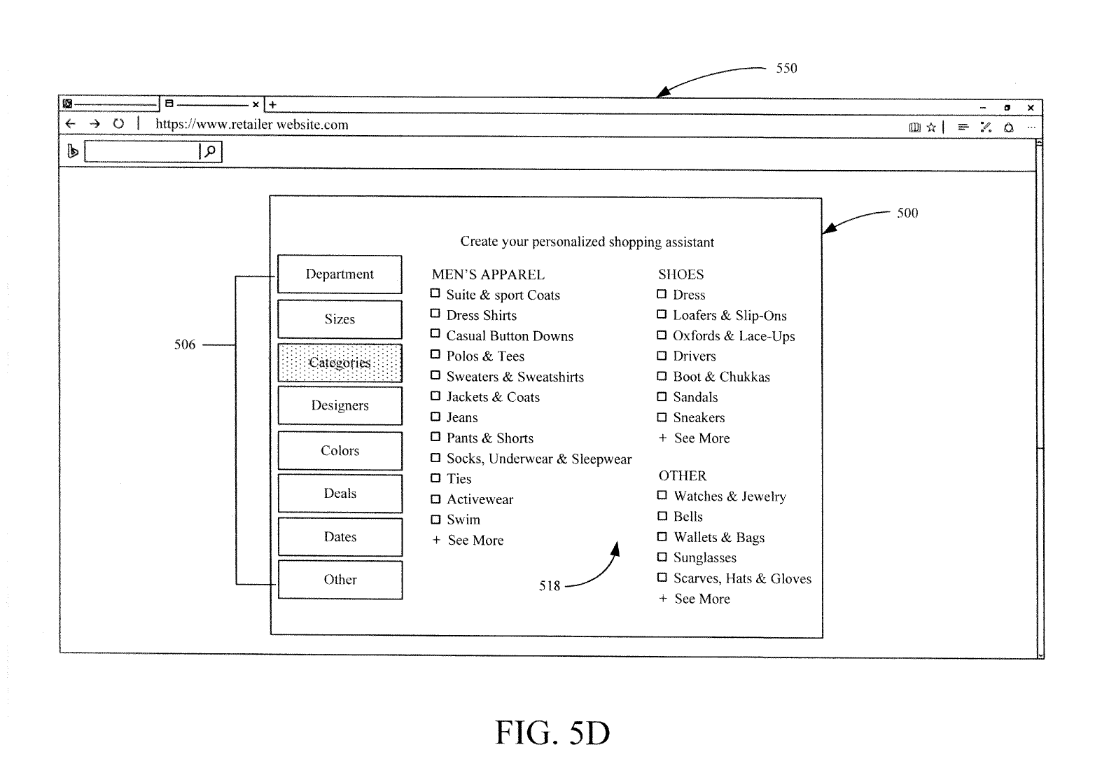

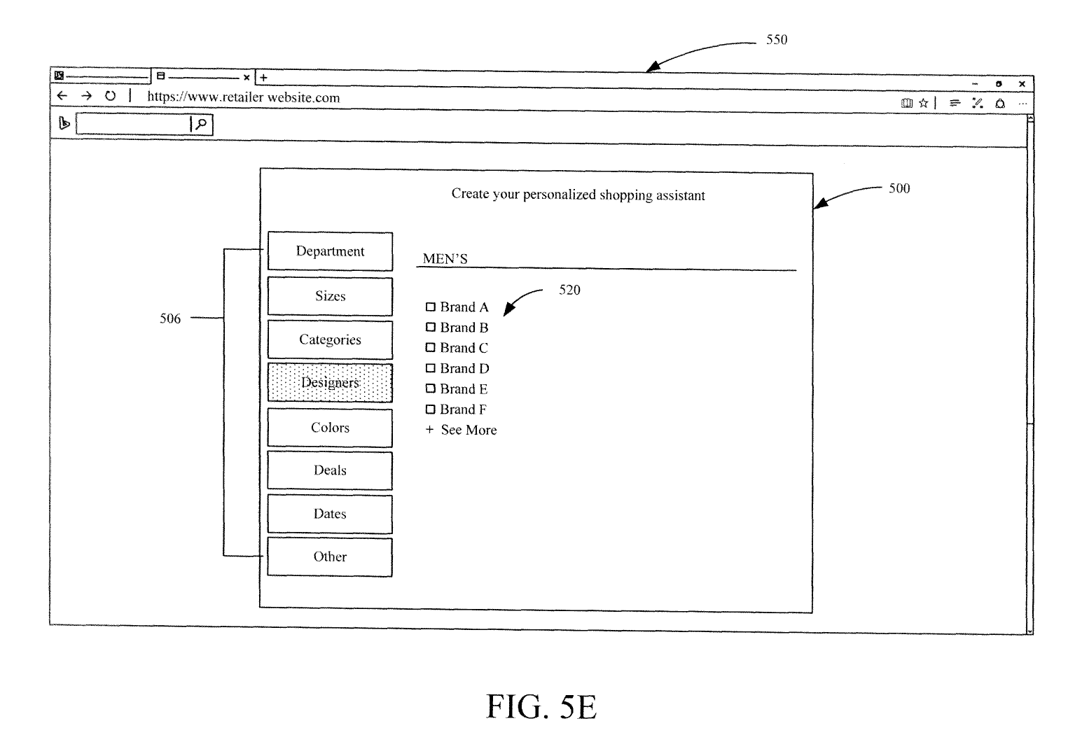

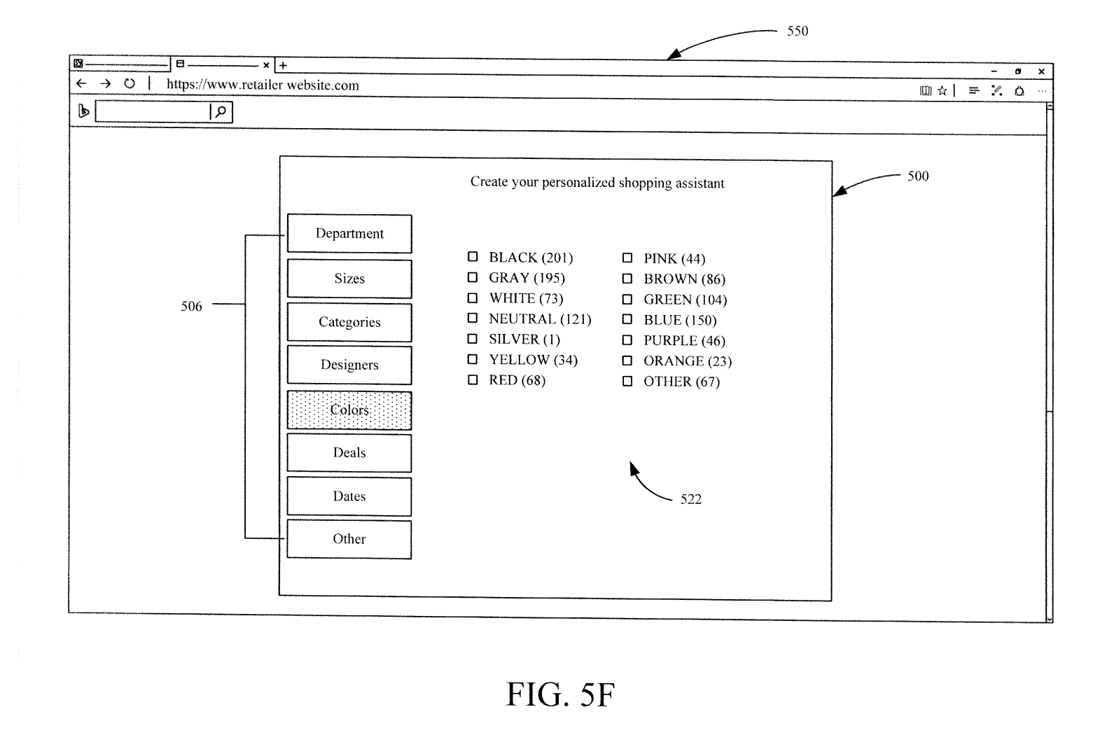

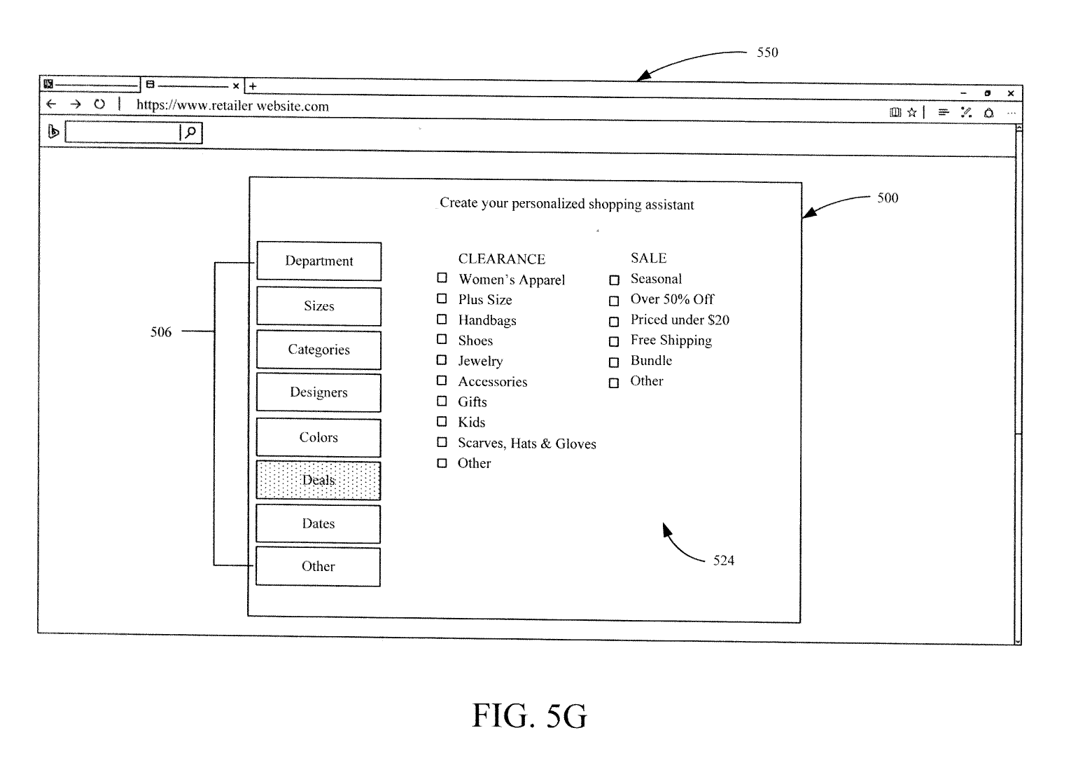

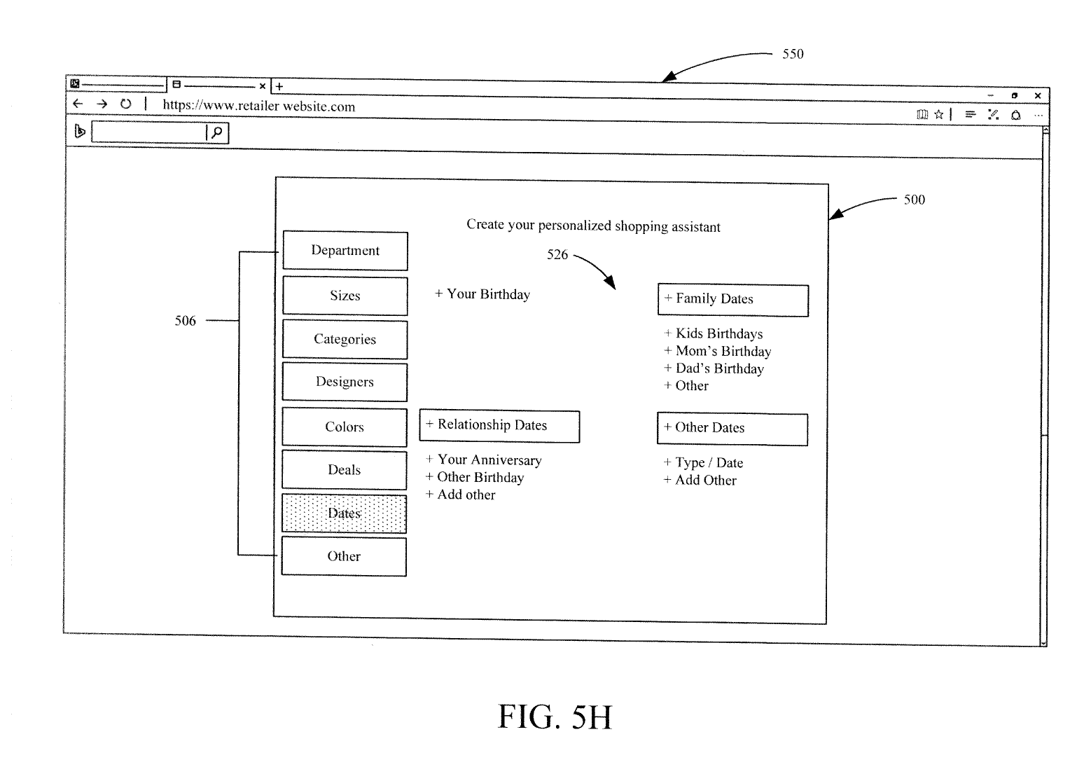

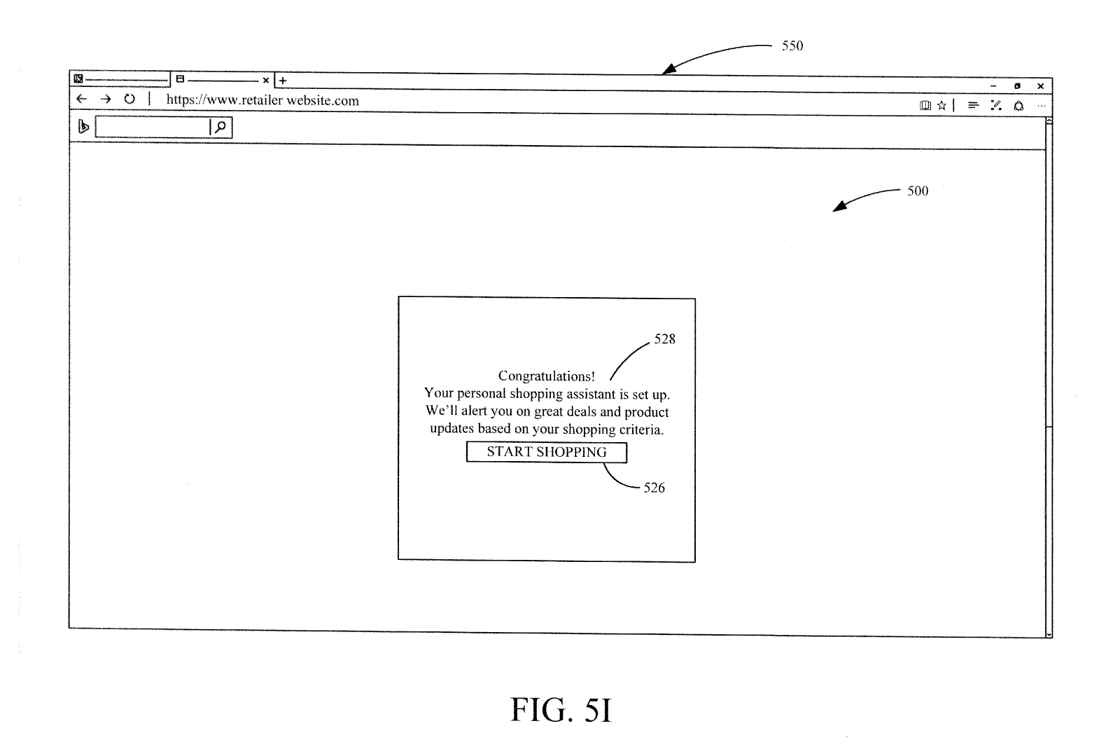

FIGS. 5A-5I show example user interface displays for personalizing alerts, in accordance with one embodiment of the present invention.

FIG. 5A illustratively shows a personalizer menu 500. In the illustrated embodiment, personalizer menu 500 is generated with web browser interface 550. In one embodiment, web browser interface 550 includes a commercial access point (e.g. a retailer website). Upon access to page 550, for instance, a commercial coordination component may instruct a personalizer administrator to automatically generate a personalizer menu. In another embodiment, a personalizer menu is generated based on one or more conditions set with personalizer administrator.

In one embodiment, personalizer menu 500 includes registration input mechanisms 502. A variety of unique identifications may be received with registration input mechanism 502. For example, registration input mechanism 502 may be configured to receive any of: a name, a username, a unique purchase history, IP address, social media profile, phone number, among others.

For example, a user may actuate input 504 to instruct the system to create a unique profile. Creating a unique profile is generally indicated by block 406 of method 400. Personalizer administrator 158 is configured to generate a unique profile that is identifiable by the provided user identification. Information regarding the unique profile may be stored at alert data store 112 or another suitable storage location.

Additional user input mechanisms generated at personalizer menu 500 illustratively include profile configuration inputs such as an image selector 510 that allows a user to select a picture 512 that will be associated with the unique profile. Personalizer administrator 158 is also configured to integrate with social platforms. In one embodiment, personalizer menu 500 includes a social connection input mechanism 508 that, when actuated, instructs administrator 158 to link the unique profile to a user's social profile.

In one embodiment, personalizer menu 500 also includes personalization input mechanisms 506. In one embodiment, personalization input mechanisms 506 are configured to receive raw interest indications. Personalization input mechanisms 506 can include a variety of inputs to identify, generally, one or more features of products that the user is interested in. Illustratively, personalization input mechanism 506 comprise inputs that allow a user to specific size, color, dates, designers, categories, and deals that the user is interested in.

FIG. 5B illustratively shows that personalization input mechanisms 506 are provided with personalizer menu 500. In one embodiment, FIG. 5B includes a first personalizer menu prompt in the detail sequence with department input mechanisms 514. Department input mechanism 514 may be actuated to select whether products should be narrowed down to either men's or women's clothing departments. The system may receive actuation of one of mechanism 514 and, in response, store the identified information in accordance with the unique identification of the user providing the input.

A personalizer administrator may continue to obtain information in accordance with the detail sequence. In one embodiment, a personalizer administrator will proceed to an additional category of personalization input mechanisms 506 upon receiving an input at the current mechanism (e.g. mechanism 514 identifying a department). In another embodiment, a personalizer administrator configures personalizer menu 500 such that a user can, at any time in the detail sequence (e.g. the various interfaces that prompt the user for detailed interest information) select a different personalization input mechanism 506. This may provide users with the flexibility of choosing a level of detail to provide to the personalizer administrator. In addition, where users are given the option to choose which details to provide, the users may be more likely to complete a sequence at their own pace or in accordance with their own time constraints rather than address all input categories 506 presented.

FIG. 5C illustratively shows one example interface of a size selection step in the detail sequence, the size selection step including a personalization input mechanism 506 that identifies sizes. As such, user interface display 500 illustratively includes size input mechanisms 516. In one embodiment, size input mechanism 516 are selectable to further define the detail sequence and store more accurate alerting preferences. To further improve accuracy of alerting, in one embodiment, a personalizer administrator is configured to generate content of a personalizer menu based on information obtained earlier in the detail sequence. As such, a personalizer menu may display dynamically updated options for customizing alerts as the user provides indications of interest. For instance, where a user actuates the men's department input mechanism (e.g. input mechanism 514), the system will generate size input mechanisms 516 that correspond to sizes in the men's department of a commercial provider. In addition, any or all of the input mechanisms described herein can be generated based on information specific to the retailer providing a commercial access point (e.g., product information 132 and/or inventory information 134). For instance, where a commercial provider sells only children's clothing, information at the commercial access point will be specific to children's clothing sizes. Therefore, in response to actuation of the ‘sizes’ personalization input mechanism 506, the system may generate size input mechanism 516 that are indicative of children's clothing sizes.

FIG. 5D illustratively shows one example interface of a category selection step in the detail sequence, the step including a personalization input mechanism 506 that identifies categories. As shown in FIG. 5D, user interface displays 500 includes category user input mechanisms 518.

FIG. 5E illustratively shows one example interface of a designer selection step in the detail sequence. For example, designer user input mechanisms 520 are generated at the designer selection step. Here, a user can provide one or more selections of designers for which the user would like to receive related alerts.

Further, FIG. 5F illustratively shows one example interface of a color selection step in the detail sequence. For example, personalizer menu interface 500 includes color user input mechanisms 522.

Further, FIG. 5G illustratively shows one example interface of a deal selection step in the detail sequence. FIG. 5G illustratively shows a personalizer menu interface 500 that includes deals user input mechanisms 524. In one embodiment,

Further, FIG. 5H illustratively shows one example interface of a date selection step in the detail sequence. Further, FIG. 5H illustratively shows a personalizer menu interface 500 including dates user input mechanisms 526 such as, but not limited to, dates for birthdays, families, relationships, and customizable (e.g. other) dates.

Upon generation of the personalized alerts, the system may also be configured to provide a user with a confirmation prompt interface 528. Confirmation prompt interface 528 is generally shown in FIG. 5I. Interface 528 may include a dialog that notifies the user that the detail sequence of prompts is complete, and that the user can now continue shopping for products at commercial access point 130 by actuating a begin shopping user input mechanism 526.

As noted above with respect to FIG. 1, alerts can be provided to users in a variety of different ways. For one, with respect to personalizer administrator 158, alerts may be provided to communications component 142 to facilitate generating an email communication that is further provided to communications client 140. Ultimately, user 138 will receive personalized alerts that are based on the information provided with the interfaces of personalizer menu 160 (e.g. illustratively shown in FIG. 5A-5I).

In addition to providing custom alert throttling for retailers and a dynamic interest identifier to personalize alerts for consumers, embodiments described herein may use a system to generate price variation predictions. The system may determine historical pricing, predict future pricing, and allow a user to select, categorize, and store products for product price tracking. Embodiments may be implemented across a variety of retail services, such as a variety of retail websites, thereby allowing users to track multiple products at different retailers.

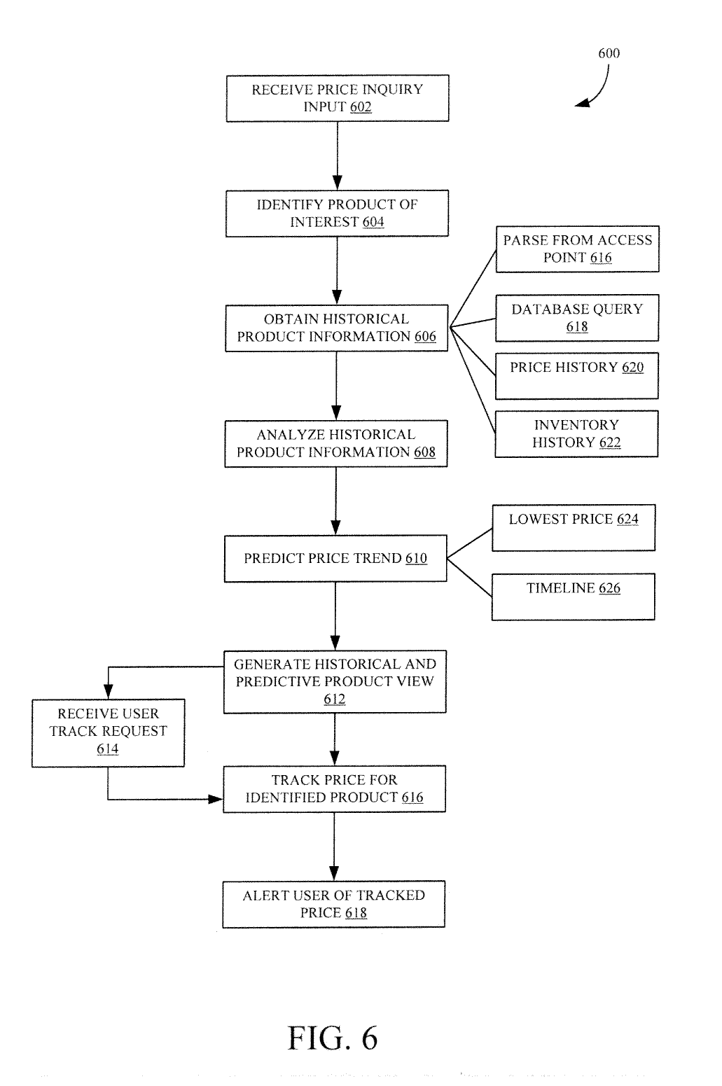

FIG. 6 illustratively shows a flow diagram of a method of generating price variation predictions, in accordance with one embodiment of the present invention. Method 600 illustratively shows that a system described herein generates an alert in response to a price inquiry input. At block 602, a price inquiry input is received. In one embodiment, receiving a price inquiry input may include receiving actuation of a variety of user input mechanisms. For purposes of discussion, but not by limitation, method 600 will be primarily discussed in the context of web browsing activities. In particular, a user may access a website of retailer and browse a product catalog to find a specific product. For example, a user may access commercial access point through a network connection. Upon finding a particular product of interest, the user might select the product to navigate to a product web page that contains detailed product information.

In one embodiment, the system is configured to determine that a product web page (e.g. commercial access point 130) is currently being accessed. The system may generate an input mechanism in response to determining that a product web page is currently being viewed. For instance, the system generates a web browser plugin that may be actuated to initiate a price variation prediction. Of course, a variety of other user input mechanism can be configured to receive a price inquiry input. For purposes of discussion, receiving a price query input, as indicated at block 602, includes receiving a web browser plugin activation. As such, a user may actuate a price inquiry input by actuating a web browser plugin to launch historical and predictive viewer 162.

At block 604, in one embodiment, a product of interest is identified. In one embodiment, identifying a product of interest can include receiving an explicit input that identifies a product. For example, a search input that includes the name of a product is received. In one embodiment, identifying a product of interest comprises using OCR or another text-based recognition mechanism to identify product information at a commercial access point. For example, the system may identify the product described at the web page by parsing a SKU number, product name, model number, or any other product identifier. For instance, a commercial coordination component may parse textual information determined to be relevant to the identification of a product of interest.

At block 606, in one embodiment, historical product information is obtained. In one embodiment, the system is configured to obtain product information and, if necessary, inventory information. Obtaining product information includes, in one embodiment, obtaining price history, as indicated at block 620. In another embodiment, obtaining product information includes obtaining inventory information, as indicated at block 622. As discussed above with respect to a commercial provider, product information and inventory information can be stored at a database associated with a commercial provider or, for instance, included at commercial access point. For the former, obtaining product information may include performing a database query, as indicated at block 618. For example, the system may call on a database such that an alert data store receives the historical product information from a commercial data store. As such, obtaining historical information, as indicated at block 606, can include storing the obtained information at a data store (e.g. store 112). In addition, the system can be configured to obtain historical product information from a variety of commercial providers. Obtaining historical information by parsing information from a commercial access point is shown at block 616. Historical product information can include prices and corresponding times at which the product was offered at those prices, previous coupon or special deals offered with the product, or a variety of other information useful to a historical and predictive viewer.

At block 608, in one embodiment, historical product information is analyzed. In one embodiment, the system uses an analysis component to map the obtained historical information in a tabular form. In one embodiment, analyzing historical product information includes performing statistical analyses on the obtained product information to determine trends or patterns.

At block 610, in one embodiment, a price trend is predicted. Predicting a price trend, in one embodiment, may include using obtained analysis information to predict future prices and the times at which those prices might be offered by a commercial provider. In one embodiment, predicting a price trend includes identifying a lowest predicted price. This is generally indicated at block 624. In another embodiment, predicting a price trend includes determining a timeline of prices with the analyzed product information. Determining a timeline of prices associated with a date of that price being offered is generally indicated by block 626.

At block 612, in one embodiment, a historical and predictive product view is generated. In one embodiment, a historical and predictive product view includes a user interface display with a product pricing graph, representing the price of the identified product over time. In addition, the view can include user input mechanism that allow a user to save the determined information for later use.

At block 614 a user track request is received. The historical and predictive viewer may include user input mechanisms that allow a user to select a product for price tracking. Actuation of a track request user input mechanism may instruct the system to store the obtained historical information, the analysis information, and the price predictions for use in potential further price alerting.

At block 616, in one embodiment, prices for the identified product are tracked. For example, but not by limitation, tracking prices can include performing price monitoring by re-obtaining product information, such as by sending a request to a commercial data store at regularly scheduled intervals. Tracking product prices can include a wide variety of other mechanisms to maintain an up-to-date register of historical pricing. For instance, the prices may be automatically tracked such that a user indication to perform price tracking is not required.

At block 618, in one embodiment, a user is alerted of a tracked price. Alerting a user of tracked price may include alerting at a regularly defined interval. For example, the system may send an alert once every week. Further, for example, the system may send an alert in response to a certain condition being met. For example, an alert may be sent to a user when a price has dropped to its lowest historical point, to a price requested by a user, or when an item has gone on sale, been marked as clearance, or another condition. Of course, alerting the user may be based on another configurable setting.

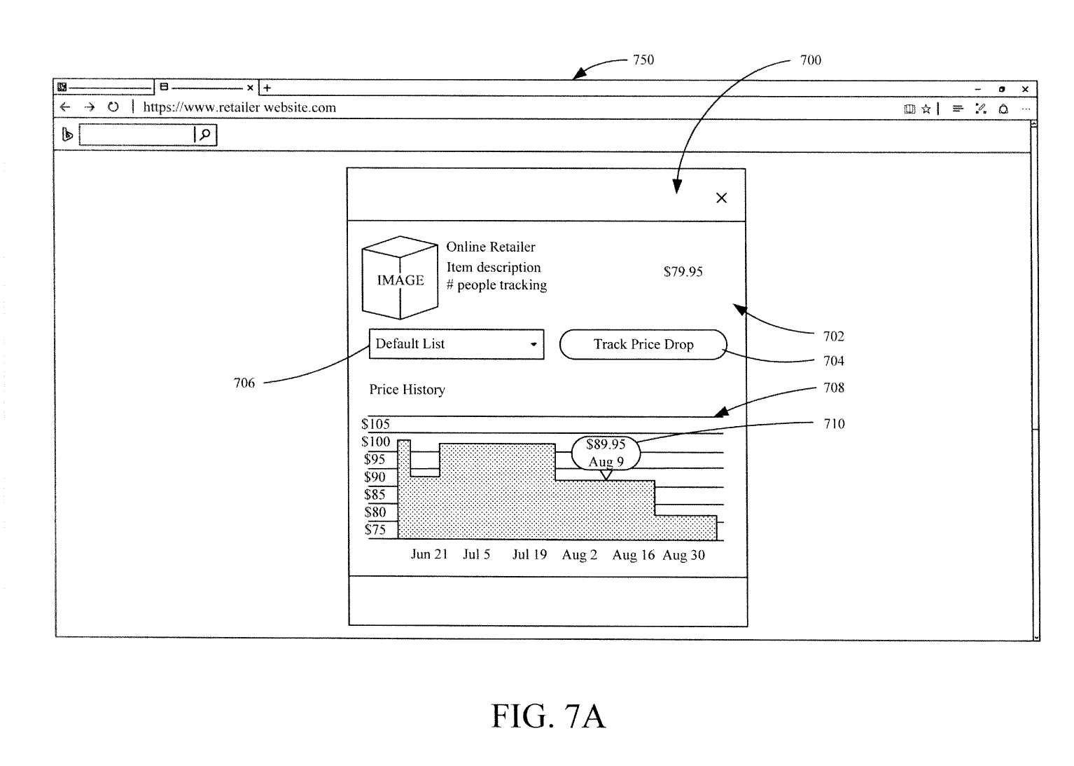

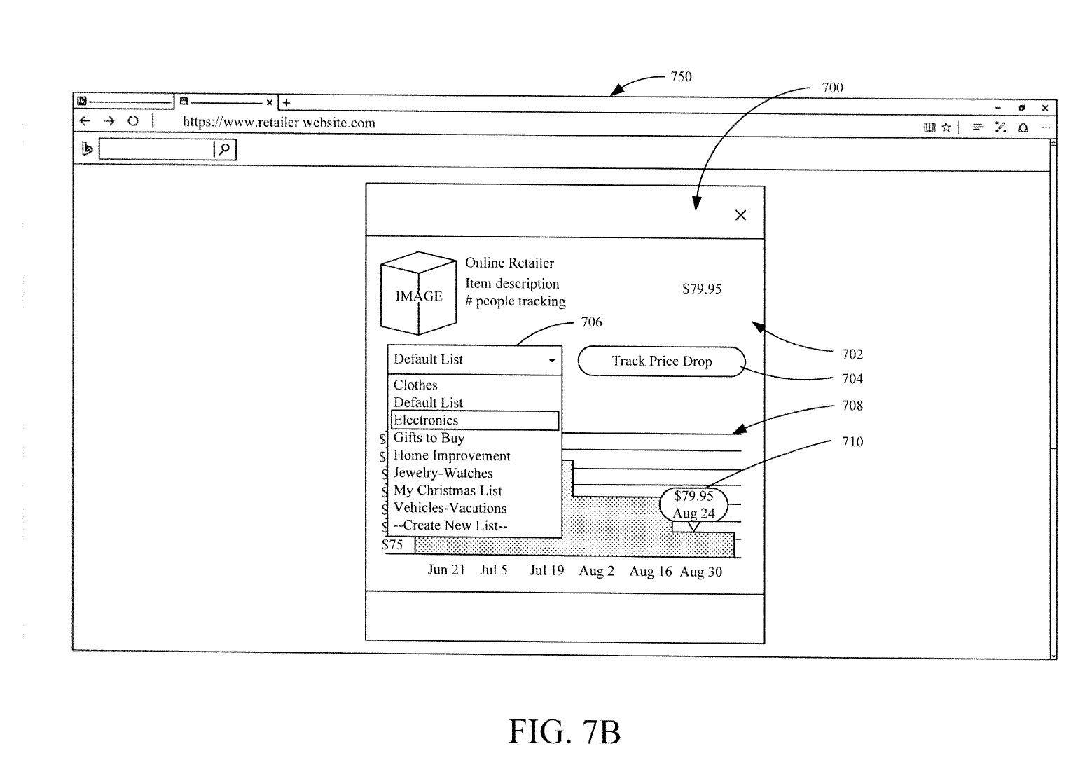

FIGS. 7A-7B show example user interface displays for generating price variation predictions, in accordance with on embodiment. FIG. 7A illustratively shows a historical and predictive interface display 700 (e.g., using historical and predictive viewer 162) incorporated with a retailer website 750 (e.g., commercial access point 130) to illustrate fluctuations in the price of a product over time. It is shown in FIG. 7A that display 700 includes a product description 702, a price track user input mechanism 704, a category user input mechanism 706, a price history graph 708, and an actuable price indicator 710. In one embodiment, actuable price indicator 710 is movable along price history graph 708 to display an indication of the price for a particular time. As such, a user may slide indicator 710, for example along the x-axis of the graph, to receive an indication of a price (see FIG. 7B in which indicator 710 has been moved to August 30). In one embodiment, this detailed viewer can be generated without leaving the product web page.

FIG. 7B illustratively shows a historical and predictive interface display 700, with a category input mechanism having been actuated. For purposes of illustration only, a user may have interest in purchasing a product, but would like to wait until the price of the product has decreased. Using a conventional, virtual shopping bin to save the product for later action requires that the user manually return to the retailer website to view the product and determine if the price has changed. At least some embodiments described herein provide a system that allows a user to opt-in to receiving alerts for a particular product of interest, where those alerts are generated based on an automatically determined change in price. As such, FIG. 7B illustratively shows that a system has received actuation of a category input mechanism 706. Actuation of category input mechanism 706 generates a drop-down menu of a list of categories to which the product of interest may be added. The categories of tracked products may be used to generate alerts for whole-lists or groups of products within individual lists.

Upon receiving a category selection, in one embodiment, the system may receive actuation of price track user input mechanism 704. Actuation of price track mechanism 704 may instruct the system to track the price for the identified product and alert the user of the tracked price, in accordance with one or more configurable rules. By linking to a user's account, for example, the system can provide notifications that indicate that the price of the product has decreased, increased, remained the same, or that there is a predicted price change. In another embodiment, the system links to a user's e-mail address and sends e-mail-based notification. Any of the alerting features described herein can be utilized with the price variation alerts. In addition, while a line-chart is illustrated, it is expressly contemplated that the system can generate a variety of user interface displays for historical price data. For example, the data can be represented in a bar graph, pie chart, tabular, or another appropriate format.

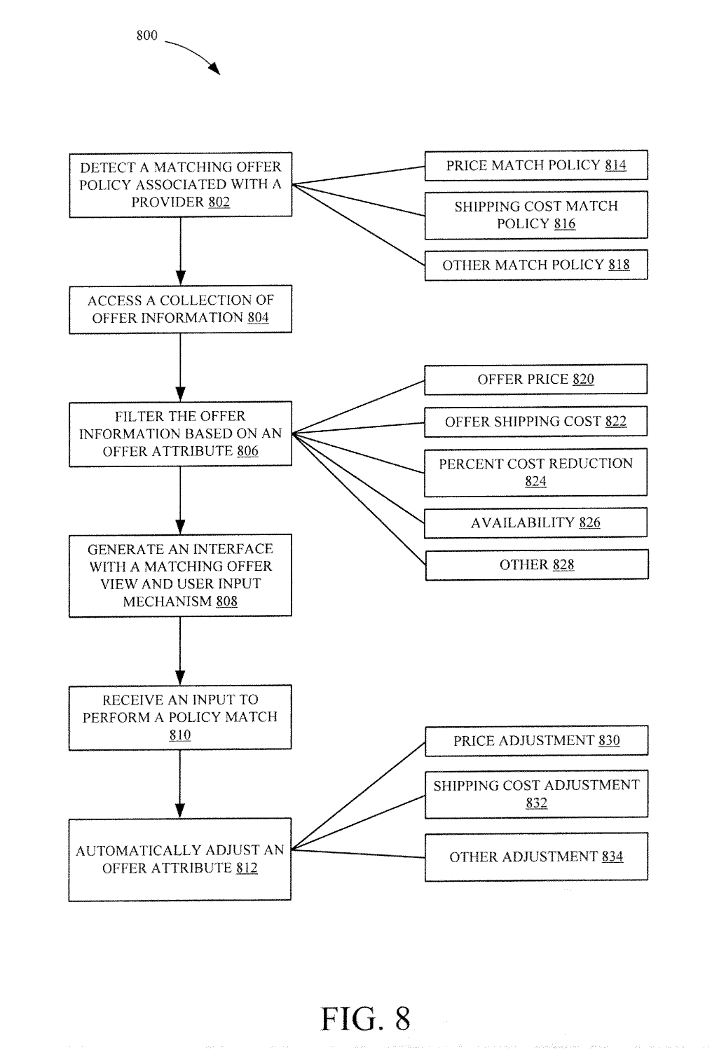

FIG. 8 shows a flow diagram of a method 800 of performing a policy match adjustment, according to one embodiment of the present invention. Method 800 illustratively includes detecting a policy offer that is associated with a provider, as indicated at block 802. A policy offer may include a wide variety of policies that are instituted by a provider, such as commercial provider 128. For example, a provider may be interested in providing an offer to consumers to retain their business, such as a specific price on a product. Price, shipping cost, product availability, and many other factors can influence the details of the offer. Competition with other providers may also influence the offer. For instance, a provider may wish to institute a policy that changes an offer of a product based on a competitor offer. As an example, a provider may institute a price match policy that states that the provider will match the price that is offered by a competitor.

In one example, commercial coordination component 144 detects an offer associated with commercial provider 128. Detecting an offer may illustratively include detecting any of: a price match policy, as indicated at block 814; a shipping cost match policy, as indicated at block 816; and other match policies, as indicated at block 818. Other match policies may include policies relating to job listings, human resource management, white papers and case studies, among others.

Method 800 also illustratively includes accessing a collection of offer information. For instance, commercial coordination component 144 may access offer information stored at any of memory 122, commercial access point 130, or commercial data store 164 in accordance with the methods disclosed herein. Accessing offer information may include accessing product information, price histories, shipping cost histories, and inventory information, among others. The accessed offer information may be parsed to, for instance, alert data store 112 by using alert mapping component 104.

At block 806, the accessed offer information is filtered based on an offer attribute. In one example, the offer attribute is identified based on the type of offer policy that is detected. For instance, the offer information may be sorted by offer price where a price match policy is detected, as indicated at block 820. Further, the offer information may be filtered and/or sorted based on any of: offer shipping cost, as indicated at block 822; percent cost reduction, as indicated at block 824; availability information, as indicated by block 826; and other attributes, as indicated by block 828.

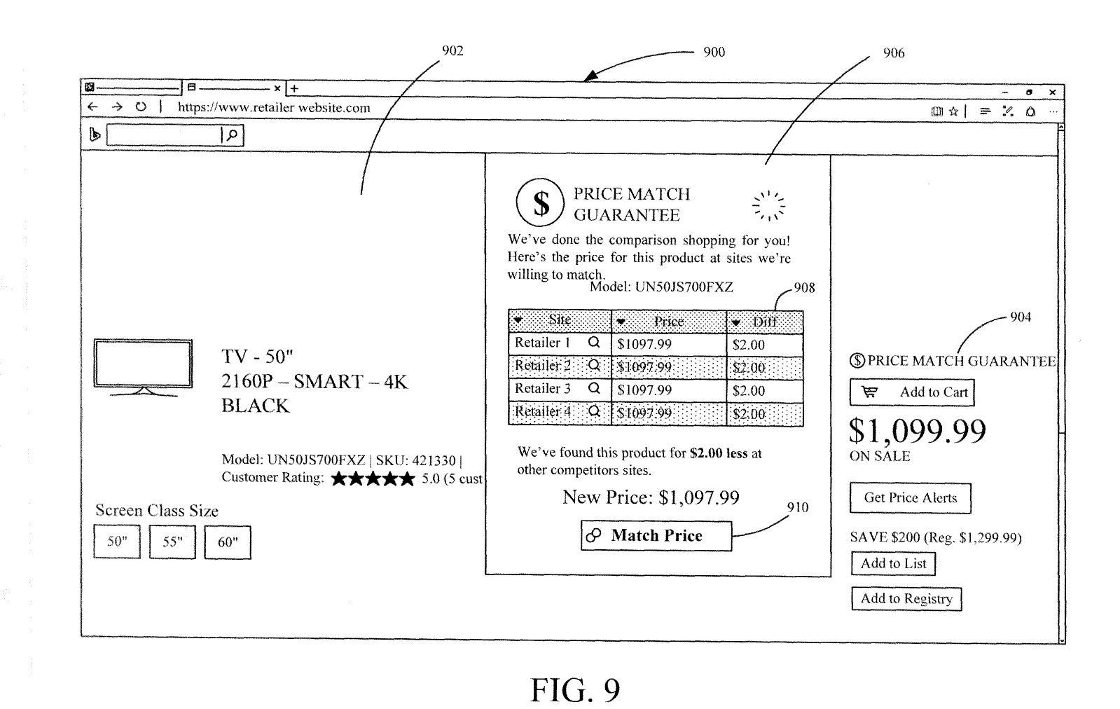

At block 808, the method illustrative includes generating a user interface with a matching offer view and one or more user input mechanisms. User interface component 124 may be configured to generate a sorted offer view. In one example, the sorted offer view is provided to commercial access point 130, such that a user may view matching offers without leaving a product web page. One example of a user interface that is generated in accordance with method 800 is shown in FIG. 9, which will be discussed in further detail below.

At block 810, an input that is indicative of performing a policy match is received. In one embodiment, the input is received with respect to a user input mechanism that is provided with a user interface display, such as the sorted offer view. In response to receiving the input, a policy match may be performed.

At block 812, the method includes automatically adjusting an offer attribute in accordance with the policy match that is performed. Adjusting an offer attribute may include adjusting a price, as indicated at block 830. For instance, the price is adjusted to reflect the lowest available price, as determined by the filtered offer information. Adjusting an offer attribute may also or alternatively include adjusting a shipping cost, as indicated at block 832. Of course, a variety of other adjustments may be performed, as indicated at block 834.

FIG. 9 shows an example user interface display 902 for a performing a policy match adjustment, in accordance with one embodiment of the present invention. FIG. 9 illustratively shows that a user interface 902 is generated, for example, within a web browser application, which is generally indicated at reference numeral 900. Interface 902 includes a variety of information relating to a commercial product offer, such as an offer to sell a television for a sale price of $1,099.99. As discussed with respect to other user interfaces herein, commercial coordination component 144 may be configured to parse information that is provided in display 902 (e.g. a commercial access point 13) such as product SKU, listed price, model number, etc. Interface 902 also illustratively includes a policy match user input mechanism 904. As an example only, and not by limitation, mechanism 904 is shown as a price match policy user input mechanism. Upon receiving actuation of mechanism 904, system 100 as described herein may perform a policy match, and generate a matching offer view 906 of the product attributes (price), as shown in pop-up display 906. Of course, a variety of other displays may be used. In the illustrated example, matching offer view 906 includes a sorted display of retailers that have been determined to offer the lowest available price for the listed television. The sorted view includes a table 908 that displays the provider, the offer price, and the difference in price from the listing at the current provider (e.g. the provider that is accessed via commercial access point 130). A user may actuate the policy match input mechanism 910 to instruct the system to automatically adjust the offered price to a determined matched price.

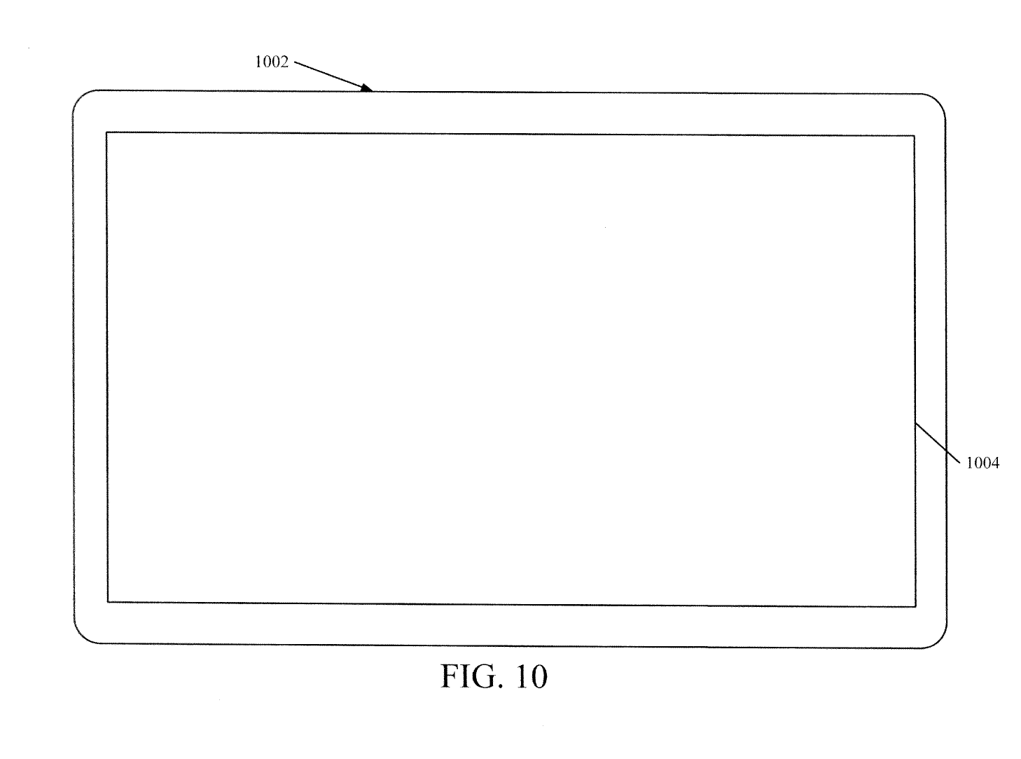

FIG. 10 shows one embodiment of a mobile computing device that may be configured to facilitate the interaction between a computing system and a user. In one embodiment, a system disclosed herein is implemented on a portable computing device 1002.

FIG. 10 illustrates a computing device 1002 with user interface display screen 1004. In one embodiment, computing device 1002 and screen 1004 may be a tablet or a mobile phone. Screen 1004 may be a touch screen or a pen-enabled interface that receives inputs from a pen or stylus. It may also use an on-screen virtual keyboard. In another embodiment, computing device 1002 may also be attached to a keyboard or another user input device. Computing device 1002 may also illustratively receive voice inputs as well. In one embodiment, display screen 1004 facilities the display of applications 122 through user interface component 104.

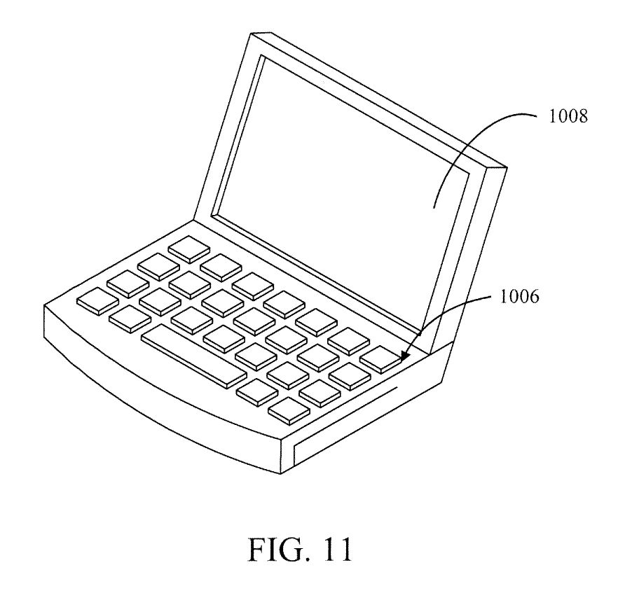

FIG. 11 shows one embodiment of a computing device that may be configured to facilitate the interaction between a computing system and a user. For example, FIG. 11 provides an additional example of a computing device that may also be used to facilitate the interaction between user 102 and computing system 101. In FIG. 11 a mobile computer such as a laptop 1006 is provided. Laptop 1006 may include display 1008 that is capable of displaying images including application images, icons, web pages, photographs, and video, and control buttons selecting items shown on the display. In one embodiment, display screen 1006 facilities the display of applications 122 through user interface component 104.

A variety of user interfaces have been discussed. These user interfaces may include a wide variety of display configurations that have user input mechanisms. User input mechanisms may include search boxes, text boxes, check boxes, drop-down menus, icons, links, etc. The user input mechanisms may be actuated in a variety of ways. For example, where the user interface is displayed on a touch-sensitive display device, the inputs may be actuated by touch gestures or motions relative to the screen. Similarly, where the device supports voice recognition and processing, the inputs may be actuated by various voice commands. Where the display device comprises a laptop computer, user input mechanisms may include mechanical buttons. Mechanical buttons may include, for example, switches, joysticks, keyboard, thumb switches, etc. In addition, the display device may be configured to include a combination of mechanical (or hardware) and touch or voice input mechanisms. For example, the laptop as shown in FIG. 11 may include keyboard, mouse, and touch-sensitive display screen input mechanisms.

Various processors and servers have also been discussed. Processors and severs described herein may be functional parts of the system that facilitate the functionality of various components of the system. Servers may include any server that is configured to facilitate database services for the data stores of the system. The processors and servers may have separate circuitry and timing components that are not shown in the figures.

It will be noted that the above discussion has described a variety of different systems, components, modules, elements, and/or types of items. It should be understood that these can be implemented in any of a variety of ways. For example, they can be implemented as logic. It will be appreciated that such systems, components, and/or logic can be comprised of hardware items (such as processors and associated memory, or other processing components, some of which are described above) that perform the functions associated with those systems, components and/or logic. In addition, the systems, components and/or logic can be comprised of software that is loaded into a memory and is subsequently executed by a processor or server, or another computing component, as described above. The systems, components and/or logic can also be comprised of different combinations of hardware, software, firmware, etc., some examples of which are described herein. These are only some examples of different structures that can be used to form the systems, components and/or logic described above. Other structures can be used as well.

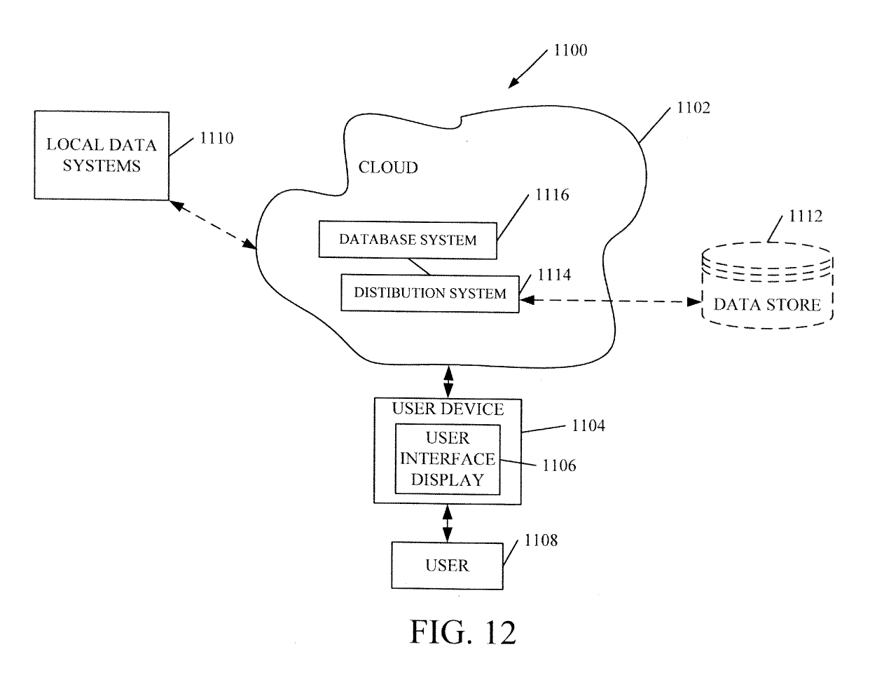

FIG. 12 illustrates a block diagram of one embodiment of a computing environment. In one embodiment, FIG. 12 is a block diagram of a cloud computing architecture 1100. In general, cloud computing allows for data distribution over a network connection, such network 1102, without requiring a knowledge of the physical location or a configuration of system 1114. Cloud computing may allow a service provider to provide access to a software application over the network and through a web portal such as a web browser application. In the embodiment shown in FIG. 12, cloud 1102 provides user devices 1104 (and user interface displays 1106) and thus users 1108 access to distribution system 1114. For instance, user 1108 may access distribution system 1114 and its associated components and their functions through an internet browser. The distribution system may supply database system 1116 and the corresponding data as a single point of access for user 1108. FIG. 12 also shows that data store 1112 and local data system 1110 may be included in cloud architecture 1100. The various components that interact with system 1114 may be included in cloud 1102 or separate from the cloud server. Where the components are not included in the cloud server 1102, they may be configured to communicate with those that are. As such, cloud architecture 1100 allows user 102 to access all the functionality of system 1114 and its data services through a single, intuitive point of access.

The cloud architecture discussed herein may include one or more configurations of either public or private cloud computing, or a combination of both public and private cloud computing. The level of security applied to the cloud computing environment may be uniquely configured by the vendor of the cloud services. In addition, the broker or vendor of local data systems may be able to configure the level of cloud environment security.

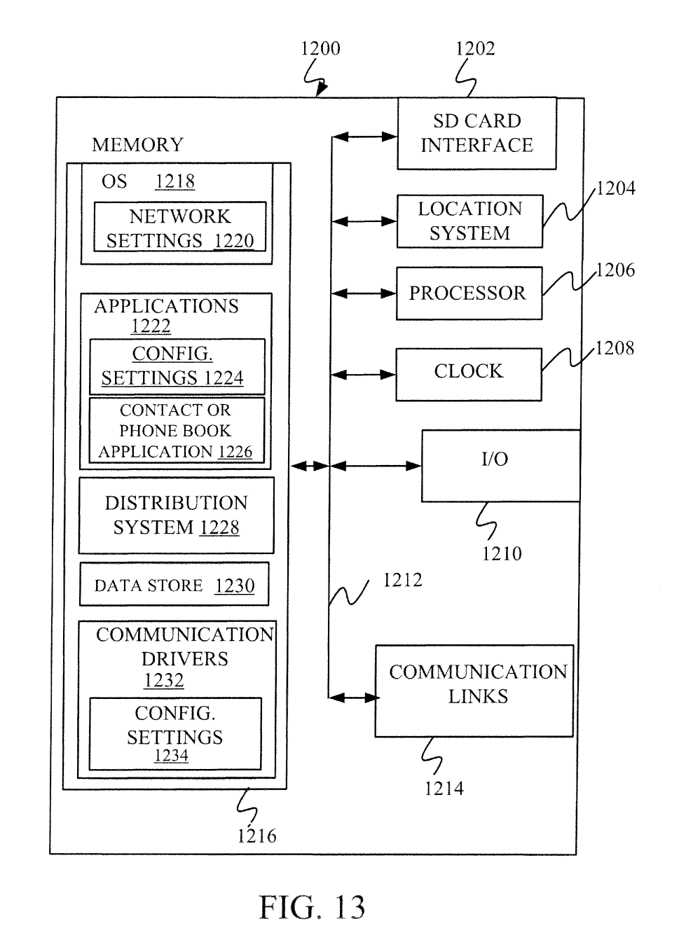

FIG. 13 illustrates a simplified block diagram of one embodiment of a computing device. For example, FIG. 13 illustrates a general block diagram of various components of computing device 1200 that may run the components of computing architecture 1100. Communication link 1214 is provided in device 1200 to allow device 1200 to communicate with the various components of system 101 and other devices. Link 1214 may include a variety of channels for receiving information and connecting device 1200 to a network, such as network 134. As such, device 1200 may be configured to communicate to other devices and applications operating in or through cloud 1102.

In one embodiment, the various component of device 1200 are interconnected by a communication bus, generally indicated by 1212. Applications and information may be received on a removable or permanent Secure Digital (SD) card that is connected to SD card interface 1202. Thus, both communication links 1214 and SD card interface 1202 communicate with processor 1206. These components may communicate via communication bus 1212, and are also connected to location system 1204, clock 1208 and input/output component (I/O) 1210.

Clock 1208 may include a real time clock that outputs a time and date, and may provide timing functionality to processor 1206. Location system 1204 may include a component that determines and/or outputs a geographical location of device 1200. Location system 1204 may include a variety of location system configurations. For example, these configurations may include a global positioning system (GPS) receiver, a long range navigation system such as LORAN, a dead reckoning system, a cellular triangulation system, or other positioning system. Location system 1204 may also provide functionality for generating map images or geographical depictions based on the determined location.

I/O components 1210 may include components such as hardware and software input buttons, touch sensors, optical sensors, microphones, touch sensitive display screens, proximity sensors, light sensors, accelerometers, orientation sensors, compass sensors. Output components may include display devices, user interface components, a speaker, a vibration mechanism, and/or a printer port, for example. A variety of other I/O components may also be used.

Memory 1216 illustratively shows storage of operating system (OS) 1218, network settings 1220, applications 1222, configuration settings 1224, contact or phone book application 1226, distribution system 1228, data store 1230, communication drivers 1232, and communication configuration settings 1234. Memory 1216 may include volatile and non-volatile memory storage, computer storage media, and any other type of memory storage.

Applications 1222 may include applications that have been previously stored on device 1200 or applications that are installed during use of distribution system 1228, for example. Applications 1222 may also include cloud-based applications that are provided by a software as a service (SaaS).

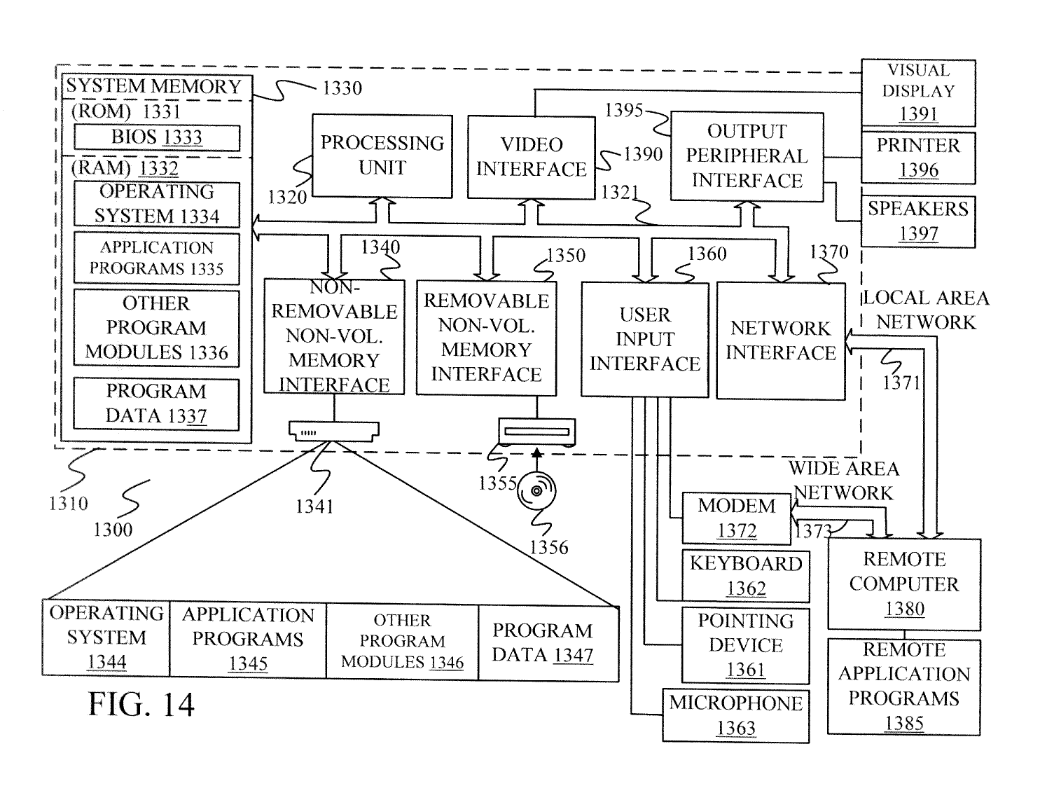

FIG. 14 illustrates a block diagram of one embodiment of an encompassing computing environment. FIG. 14 illustratively comprises a general-purpose computing device configured as a computer 1310. Computer 1310 may include a variety of components that are configured to facilitate the functionality of a distribution system, for example. Computer 1310 may include a processing unit 1320, a system memory 1330 and a communication bus 1321 that may facilitate communication between the various components. The system bus 1321 may be any of several types of bus structures including a memory bus or memory controller, a peripheral bus, and a local bus using any of a variety of bus architectures. The various applications and implementations of distribution system 100, as described herein, may be deployed in corresponding elements of FIG. 14.

Computer 1310 may comprise a variety of computer readable media. Computer readable media may be any available media that may be accessed by computer 1310 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computer 1310. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 1330 includes computer storage media in the form of volatile and/or nonvolatile memory such as read only memory (ROM) 1331 and random access memory (RAM) 1332. A basic input/output system 1333 (BIOS), containing the basic routines that help to transfer information between elements within computer 1310, such as during start-up, is typically stored in ROM 1331. RAM 1332 typically contains data and/or program modules that are immediately accessible to and/or presently being operated on by processing unit 1320. By way of example, and not limitation, FIG. 14 illustrates operating system 1334, application programs 1335, other program modules 1336, and program data 1337.

The computer 1310 may also include other removable/non-removable volatile/nonvolatile computer storage media. By way of example only, FIG. 14 illustrates a hard disk drive 1341 that reads from or writes to non-removable, nonvolatile magnetic media, a magnetic disk drive 1351, nonvolatile magnetic disk 1352, an optical disk drive 1355, and nonvolatile optical disk 1356. The hard disk drive 1341 is typically connected to the system bus 1321 through a non-removable memory interface such as interface 1340, and magnetic disk drive 1351 and optical disk drive 1355 are typically connected to the system bus 1321 by a removable memory interface, such as interface 1350.

Alternatively, or in addition, the functionality described herein may be performed, at least in part, by one or more hardware logic components. For example, and without limitation, illustrative types of hardware logic components that may be used include Field-programmable Gate Arrays (FPGAs), Program-specific Integrated Circuits (e.g., ASICs), Program-specific Standard Products (e.g., ASSPs), System-on-a-chip systems (SOCs), Complex Programmable Logic Devices (CPLDs), etc.

The drives and their associated computer storage media discussed above and illustrated in FIG. 14, provide storage of computer readable instructions, data structures, program modules and other data for the computer 1310. In FIG. 14, for example, hard disk drive 1341 is illustrated as storing operating system 1344, application programs 1345, other program modules 1346, and program data 1347. Note that these components may either be the same as or different from operating system 1334, application programs 1335, other program modules 1336, and program data 1337.

A user may enter commands and information into the computer 1310 through input devices such as a keyboard 1362, a microphone 1363, and a pointing device 1361, such as a mouse, trackball or touch pad. Other input devices (not shown) may include a joystick, game pad, satellite dish, scanner, or the like. These and other input devices are often connected to the processing unit 1320 through a user input interface 1360 that is coupled to the system bus, but may be connected by other interface and bus structures. A visual display 1391 or other type of display device is also connected to the system bus 1321 via an interface, such as a video interface 1390. In addition to the monitor, computers may also include other peripheral output devices such as speakers 1397 and printer 1396, which may be connected through an output peripheral interface 1395.

The computer 1310 is operated in a networked environment using logical connections (such as a local area network—LAN, or wide area network WAN) to one or more remote computers, such as a remote computer 1380.

When used in a LAN networking environment, the computer 1310 is connected to the LAN 1371 through a network interface or adapter 1370. When used in a WAN networking environment, the computer 1310 typically includes a modem 1372 or other means for establishing communications over the WAN 1373, such as the Internet. In a networked environment, program modules may be stored in a remote memory storage device. FIG. 14 illustrates, for example, that remote application programs 1385 may reside on remote computer 1380.

At least some of the present embodiments discussed herein provide a system that assigns value to data by which data producers, data aggregators, and data consumers may collect, distribute, sell, or trade data. The Internet of Things is an example of a system generating data from sensors and other electronic devices at an ever increasing rate. When this data is combined with data from traditional sources, the value and utility of the sources increases, leading to the potential to analyze data for social good, research and discovery, achieving business objectives, and an overall increase in accuracy and validity of data use on a daily basis. Embodiments of the current disclosure may be directed towards and electronic marketplace that utilizes a platform to assign a unique token to a participant or local data source, tracking the data published by the participant, and assigning a value to the data based on a combination of data valuation metrics.

Although the present invention has been described with reference to preferred embodiments, those skilled in the art will recognize that changes may be made in form and detail without departing from the spirit and scope of the invention.

What is claimed is:

1. A computer-implemented method of throttling an offer alert, comprising:
displaying, on a display, a user interface including a user intent input mechanism;
receiving, from a user, a user intent input with the user intent input mechanism, the user intent input corresponding to a product;
determining a product condition corresponding to the product;
in response to determining the product condition, identifying, using an alert configuration component, an alert configuration for the product;
generating, using an alert generator, an offer alert based on the alert configuration; and
providing the offer alert, using a communication component, to the user.

2. The computer-implemented method of claim 1, wherein determining that the product is unavailable comprises:
obtaining availability information corresponding to the product.

3. The computer-implemented method of claim 2, wherein obtaining availability information comprises:
accessing inventory information from a commercial provider.

4. The computer-implemented method of claim 3, wherein accessing inventory information comprises requesting, with a commercial coordination component, a current inventory level of the product from a paired inventory system.

5. The computer-implemented method of claim 1, wherein receiving the user intent input comprises receiving actuation of a user intent input mechanism at a commercial provider, the user intent input being indicative of a request to acquire the product.

6. The computer-implemented method of claim 1, wherein identifying the alert configuration for the product comprises:
identifying a ratio configuration, wherein the ratio configuration is indicative of a ratio of alert generation to consumer interest.

7. The computer-implemented method of claim 1, wherein identifying the alert configuration for the product comprises:
identifying an interval timing configuration, wherein the interval timing configuration is indicative of an alerting schedule.

8. The computer-implemented method of claim 1, wherein identifying the alert configuration for the product comprises:
identifying a batch configuration, wherein the batch configuration is indicative of a group of products.

9. The computer-implemented method of claim 1, wherein identifying the alert configuration for the product comprises:
identifying a conditional formatting configuration.

10. The computer-implemented method of claim 1, further comprising:
monitoring at least one alert configuration associated with the product; and
based on the monitoring of the at least one alert configuration, throttling the offer alert.

11. The computer-implemented method of claim 1, further comprising:
generating a user interface display with a user interface component, the user interface display comprising an offer request user input mechanism; and
receiving a user request input with the offer request user input mechanism.

12. A computing system comprising:
a processor; and
memory storing instructions executable by the processor, wherein the instructions configure the computing system to:
generate a user interface display comprising a personalization user input mechanism;
receive, from a user, a personalization user input corresponding to the personalization user input mechanism;
obtain a detail sequence, the detail sequence being indicative of the personalization user input;
generate a personalized alert based on the obtained detail sequence, the personalized alert comprising an alert condition;
detect that the alert condition is met; and
send the personalized alert, using a communication component, to the user.

13. The computing system of claim 12, wherein the instructions further configure the computing system to:
receive a unique identifier associated with a user; and
store the unique identifier with the obtained detail sequence.

14. The computing system of claim 13, wherein the instructions further configure the computing system to:
receive a user actuation of the personalization user input mechanism; and
provide an indication of the user actuation to the detail sequence.

15. The computing system of claim 13, wherein the instructions further configure the computing system to:
analyze the obtained detail sequence; and
identify at least one product of interest to the user, based on the analysis.

16. the computing system of claim 15, wherein the personalized alert comprises a product offer for the product of interest to the user.

17. A computer-implemented method of providing price variation alerts, the method comprising:
identifying a product of interest;
obtaining historical product information associated with the product of interest;
receiving a user tracking request, from a user, with a user request input mechanism;
in response to the user tracking request, automatically tracking the identified product of interest;
detecting a price variation, wherein detecting the price variation comprises comparing a first detected price to a second detected price;
generating a price alert indicative of the price variation; and
providing the price alert, using a communication component, to the user.

18. The computer-implemented method of claim 17, further comprising:
generating a historical product view, the historical product view including the obtained historical product information.

19. The computer-implemented method of claim 17, further comprising:
performing an analysis on the obtained historical product information; and
generating a price variation prediction based on the analysis.

20. The computer-implemented method of claim 17, wherein obtaining historical product information comprises generating a request, using a commercial communication component, for historical product pricing associated with the product of interest.
